(19) United States
(12) Patent Application Publication
(10) Pub. No.: US 2017/0336626 A1
(43) Pub. Date: Nov. 23, 2017

(54) DISPLAY DEVICE AND DISPLAY CONTROL METHOD

(71) Applicant: Sony Corporation, Tokyo (JP)

(72) Inventors: Masatake Hayashi, Kanagawa (JP); Takeo Arai, Aichi (JP); Motohiro Kobayashi, Kanagawa (JP)

(73) Assignee: Sony Corporation, Tokyo (JP)

(21) Appl. No.: 15/522,881

(22) PCT Filed: Nov. 6, 2015
(86) PCT No.: PCT/JP2015/081406

§ 371 Date: Apr. 28, 2017

(30) Foreign Application Priority Data
Nov. 7, 2014 (JP) 2014-227279
Jan. 30, 2015 (JP) 2015-016622

(51) Int. Cl. G02B 27/00; G02B 27/10; G02B 27/01; G02C 7/02; G02B 3/00

(52) U.S. Cl. CPC G02B 27/0081; G02C 7/025; G02B 3/0056; G02B 27/0172; G02B 27/1066

(57) ABSTRACT

[Object] To provide display that is more favorable to a user.

[Solution] Provided is a display device including: a pixel array; and a microlens array provided on a display surface side of the pixel array and having lenses arranged at a pitch larger than a pixel pitch of the pixel array. The microlens array is arranged so that each lens of the microlens array generates a virtual image of display of the pixel array on a side opposite to a display surface of the pixel array, and light emitted from each lens of the microlens array is controlled so that pictures visually recognized through lenses of the microlens array become a continuous and integral display by controlling the light from each pixel of the pixel array.

### TECHNICAL FIELD

The present disclosure relates to a display device and a display control method.

### BACKGROUND ART

For display devices, increasing an amount of information to be displayed on a screen is an important mission. In view of this, in recent years, display devices capable of performing display with higher resolution such as, for example, 4K television, have been developed. Particularly, in a device having a relatively small display screen size such as a mobile device, higher-definition display is required to display more information on a small screen.

However, in addition to increasing the amount of information to be displayed on the display device, high visibility is also required. Even if higher-resolution display is performed, a degree of resolution to which display can be determined depending on the visual acuity of an observer (user). In particular, it is assumed that it is difficult for elderly users to visually recognize high-resolution displays due to presbyopia with aging.

Generally, as countermeasures against presbyopia, optical compensation instruments such as presbyopic glasses are used. However, because far visual acuity is degraded while presbyopic glasses are worn, attachment/detachment is necessary in accordance with a situation. Also, it is necessary to carry a tool for storing presbyopic glasses such as an eyeglass case in accordance with the necessity of attachment/detachment. For example, it is necessary for a user with presbyopia who uses a mobile device to carry a tool having a volume equal to or larger than that of the mobile device, so that portability, which is an advantage of the mobile device, is impaired, which feels annoying to many users. Furthermore, many users feel resistance to wearing presbyopic glasses themselves.

Therefore, in a display device, particularly, a display device having a relatively small display screen mounted on a mobile device, technology in which the display device itself improves visibility for a user without using additional devices such as presbyopic glasses is desired. For example, in Patent Literature 1, technology in which a plurality of lenses are arranged so that images of pixel groups are overlapped and projected in a display device including the plurality of lenses and a plurality of light emission point (pixel) groups and the projected images from the plurality of lenses are formed on the retina of a user by causing an overlap of pixels in the pixel groups projected and overlapped by the lenses to be incident on a user's pupil is disclosed. In the technology described in Patent Literature 1, an image with a deep focal depth is formed on the retina by adjusting a projection size of light from a pixel on the pupil to a size smaller than a pupil diameter and a user with presbyopia can also obtain an in-focus image.

### CITATION LIST

### Patent Literature

Patent Literature 1: JP 2011-191595A

### DISCLOSURE OF INVENTION

### Technical Problem

However, in the technology described in Patent Literature 1, in principle, when two or more light beams corresponding to the overlap of pixels in the pixel groups projected and overlapped by the lenses are incident on the pupil, the image on the retina will be blurred. Accordingly, in the technology described in Patent Literature 1, adjustment is performed so that an interval between light beams corresponding to the overlap of the pixels on the pupil (that is, projected images on the pupil of light from the pixels) is set to be larger than the pupil diameter and a plurality of light beams are not incident simultaneously.

However, in this configuration, when a position of the pupil has moved with respect to the lens, there is a moment when the light beam is not incident on the pupil. While the light beam is not incident on the pupil, no image is visually recognized by the user and the user can observe an invisible region such as a black frame. Because the invisible region is periodically generated every time the pupil moves by about the pupil diameter, it cannot be said that comfortable display is provided for the user.

Therefore, the present disclosure provides a novel and improved display device and display control method capable of providing display that is more favorable to a user.

### Solution to Problem

According to the present disclosure, there is provided a display device including: a pixel array; and a microlens array provided on a display surface side of the pixel array and having lenses arranged at a pitch larger than a pixel pitch of the pixel array. The microlens array is arranged so that each lens of the microlens array generates a virtual image of display of the pixel array on a side opposite to a display surface of the pixel array, and light emitted from each lens of the microlens array is controlled so that pictures visually recognized through lenses of the microlens array become a continuous and integral display by controlling the light from each pixel of the pixel array.

According to the present disclosure, there is provided a display control method including: controlling light emitted from each lens of a microlens array so that pictures visually recognized through lenses of the microlens array become a continuous and integral display by controlling light from each pixel of a pixel array, the microlens array being provided on a display surface side of the pixel array and having lenses arranged at a pitch larger than a pixel pitch of the pixel array. The microlens array is arranged so that each lens of the microlens array generates a virtual image of display of the pixel array on a side opposite to a display surface of the pixel array.

According to the present disclosure, a picture on a pixel array resolved by each lens of a microlens array is provided as a continuous and integral display to a user. Accordingly, it is possible to perform display for compensating for the visual acuity of the user without generating an invisible region as in the technology described in Patent Literature 1. Also, because resolution is not performed by light-ray reproduction, for example, a pixel size of a pixel array can be increased, a degree of freedom of design can be improved, and manufacturing costs can be decreased.

### Advantageous Effects of Invention

According to the present disclosure as described above, display that is more favorable to a user can be provided. Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is a graph illustrating an example of relationships between limit resolution and visual acuity and a viewing distance.

FIG. 2 is a graph illustrating an example of relationships between a limit resolution of a user with emmetropia and an age and a viewing distance.

FIG. 3 is a graph illustrating an example of relationships between a limit resolution of a user with myopia and an age and a viewing distance.

FIG. 4 is an explanatory diagram illustrating a concept for assigning depth information to two-dimensional picture information.

FIG. 5 is a diagram illustrating an example of a configuration of a light-ray reproduction display device.

FIG. 6 is a diagram illustrating an example of a configuration of a display device that displays a general two-dimensional picture.

FIG. 7 is a schematic diagram illustrating a state in which a user's focus is aligned with a display surface in a general two-dimensional display device.

FIG. 8 is a schematic diagram illustrating a state in which the user's focus is not aligned with the display surface in the general two-dimensional display device.

FIG. 9 is a schematic diagram illustrating a relationship between a virtual image surface in the light-ray reproduction display device and an image formation surface on a retina of the user.

FIG. 10 is a diagram illustrating an example of a configuration of a display device according to a first embodiment.

FIG. 11 is a diagram illustrating a light ray emitted from a microlens in a normal mode.

FIG. 12 is a diagram illustrating a specific display example of a pixel array in the normal mode.

FIG. 13 is a diagram illustrating a positional relationship between a virtual image surface and a display surface of a microlens array in the normal mode.

FIG. 14 is a diagram illustrating a light ray emitted from a microlens in a visual acuity compensation mode.

FIG. 15 is a diagram illustrating a specific display example of a pixel array in the visual acuity compensation mode.

FIG. 16 is a diagram illustrating a positional relationship between a virtual image surface and a display surface of a microlens array in the visual acuity compensation mode.

FIG. 17 is a diagram illustrating a relationship between a pupil diameter of a pupil of a user and a size of a sampling region.

FIG. 18 is a diagram illustrating a relationship between λ and PD when an iteration cycle λ satisfies Equation (3).

FIG. 19 is a diagram illustrating a relationship between λ and PD when an iteration cycle λ satisfies Equation (4).

FIG. 20 is a diagram illustrating an influence of the relationship between an iteration cycle λ and PD on a size of a continuous display region.

FIG. 21 is a flowchart illustrating an example of a processing procedure of a display control method according to the first embodiment.

FIG. 22 is a diagram illustrating an example of a configuration in which a display device according to the first embodiment is applied to a wearable device.

FIG. 23 is a diagram illustrating an example of a configuration in which a display device according to the first embodiment is applied to another mobile device.

FIG. 24 is a diagram illustrating an example of a general electronic loupe device.

FIG. 25 is a schematic diagram illustrating a state of a decrease of a pixel size dp due to a first shielding plate having a rectangular opening (aperture).

FIG. 26 is a schematic diagram illustrating a state of a decrease of a pixel size dp due to a first shielding plate having a circular opening (aperture).

FIG. 27 is a diagram illustrating an example of a configuration in which the first shielding plate is provided between a backlight and a liquid crystal layer.

FIG. 28 is a diagram illustrating an example of a configuration of a display device according to a modified example in which dynamic control of an irradiation state in accordance with pupil position detection is performed.

FIG. 29 is an explanatory diagram illustrating generation of a virtual image in a general convex lens.

FIG. 30 is a diagram illustrating an example of a configuration of a display device according to a second embodiment.

FIG. 31 is a flowchart illustrating an example of a processing procedure of a display control method according to the second embodiment.

FIG. 32 is a diagram illustrating an example of a configuration of a telephoto type lens system.

FIG. 33 is a diagram schematically illustrating positional relationships between positions of two eyes of a user who observes a display device and microlenses of a microlens array.

FIG. 34 is an explanatory diagram illustrating a method of designing a microlens.

FIG. 35 is a diagram illustrating an example of a configuration in which a positional relationship between microlenses of two-layer microlens arrays is shifted in accordance with a position of a viewpoint of a user in a microlens array including the two-layer microlens arrays.

FIG. 36 is a diagram illustrating an example of a configuration in which the number of microlenses mutually corresponding to two-layer microlens arrays is changed in accordance with a position of a viewpoint of a user in a microlens array including the two-layer microlens arrays.

### MODE(S) FOR CARRYING OUT THE INVENTION

Hereinafter, (a) preferred embodiment(s) of the present disclosure will be described in detail with reference to the appended drawings. In this specification and the appended drawings, structural elements that have substantially the same function and structure are denoted with the same reference numerals, and iterated explanation of these structural elements is omitted.

Also, the description will be given in the following order.

1. Background of present disclosure

### 2. First Embodiment

2-1. Basic principle of first embodiment
2-2. Display device according to first embodiment
2-2-1. Device configuration
2-2-2. Driving example
2-2-2-1. Normal mode
2-2-2-2. Visual acuity compensation mode
2-2-3. Detailed design
2-2-3-1. Sampling region
2-2-3-2. Iteration cycle of irradiation state of sampling region
2-3. Display control method
2-4. Application examples
2-4-1. Application to wearable device
2-4-2. Application to other mobile devices
2-4-3. Application to electronic loupe device
2-4-4. Application to in-vehicle display device
2-5. Modified example
2-5-1. Decrease of pixel size in accordance with aperture
2-5-2. Example of configuration of light emission point other than microlens
2-5-3. Dynamic control of irradiation state in accordance with pupil position detection
2-5-4. Modified example in which pixel array is implemented by printing material

### 3. Second Embodiment

3-1. Background of second embodiment
3-2. Device configuration
3-3. Display control method
3-4. Modified example
4. Configuration of microlens array

### 5. Supplement

### 1. Background of Present Disclosure

First, prior to describing a preferred embodiment of the present disclosure, a background that the present inventors have conceived for the present disclosure will be described.

As described above, in recent years, display devices capable of performing display with higher resolution have been developed. Particularly, in a device having a relatively small display screen size such as a mobile device, higher-definition display is required to display more information on a small screen.

However, the resolution capable of being distinguished by a user depends on the visual acuity of the user. Accordingly, even when a resolution beyond a limit of the visual acuity of the user is pursued, an advantage is not necessarily given to the user.

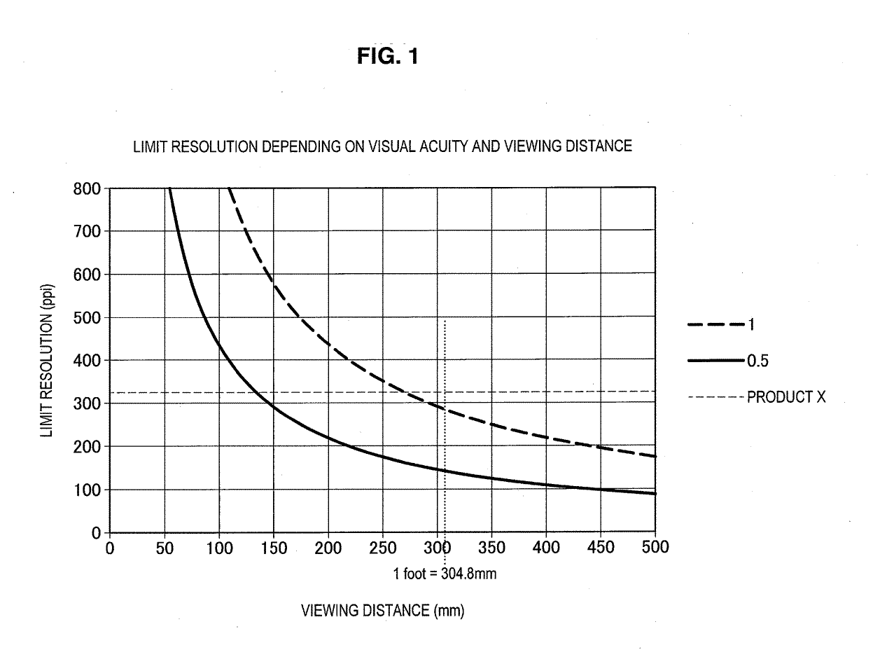

Relationships between the resolution (limit resolution) capable of being distinguished by a user and visual acuity and a viewing distance (a distance between the display surface of the display device and the pupil of the user) are illustrated in FIG. 1. FIG. 1 is a graph illustrating the relationships between the limit resolution and the visual acuity and the viewing distance. In FIG. 1, the viewing distance (mm) is taken on the horizontal axis, the limit resolution (ppi: pixels per inch) is taken on the vertical axis, and a relationship between the two is plotted. Also, the visual acuity is taken as a parameter and the relationship between the viewing distance and the limit resolution is plotted for a case in which the visual acuity is 1.0 and a case in which the visual acuity is 0.5.

Referring to FIG. 1, it can be seen that as the viewing distance increases, that is, as the distance between the display surface and the pupil increases, the limit resolution decreases. Also, it can be seen that the lower the visual acuity, the lower the resolution limit.

Here, the resolution of a product X that is generally distributed is about 320 (ppi) (indicated by a broken line in FIG. 1). From FIG. 1, it can be seen that the resolution of the product X is set to be slightly larger than the limit resolution at the viewing distance 1 (foot) (=304.8 (mm)) of a user whose visual acuity is 1.0. That is, in the product X, the resolution effectively functions in the sense that pixels cannot be recognized for a user having a visual acuity of 1.0 viewing the display surface from the distance of 1 (foot).

On the other hand, visual acuity differs depending on a user. Some users have myopia where visual acuity is degraded at a long distance, and others have presbyopia where visual acuity is degraded at a short distance due to aging. When considering the relationship between the limit resolution and the resolution of the display surface, it is also necessary to consider such a change in the visual acuity of the user depending on the viewing distance. In the example illustrated in FIG. 1, the limit resolution at the viewing distance 1 (foot) of a user whose visual acuity is 0.5 is about 150 (ppi), and only about half of the resolution of the product X can be distinguished at the same viewing distance of 1 (foot) of the user.

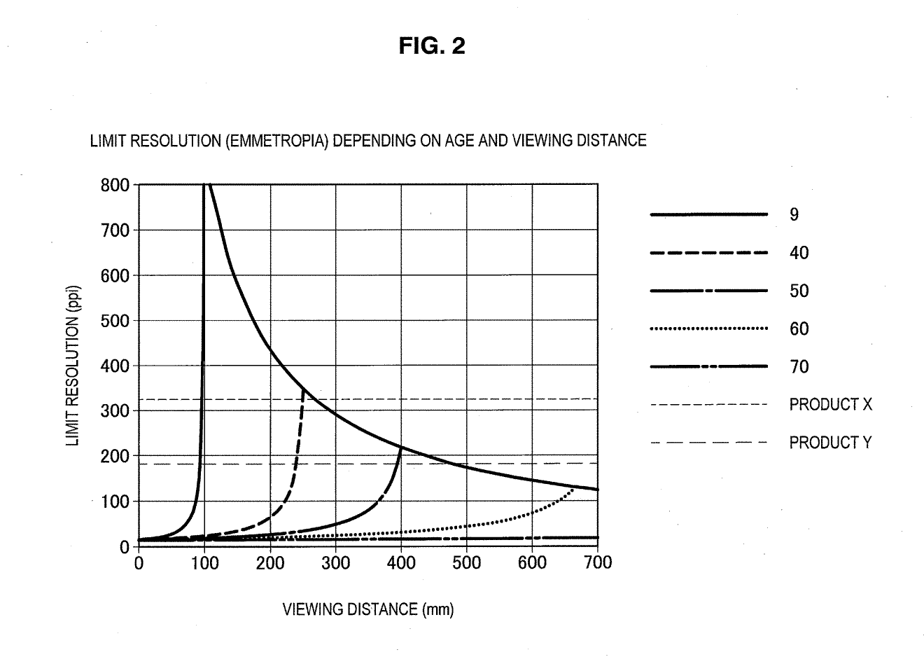

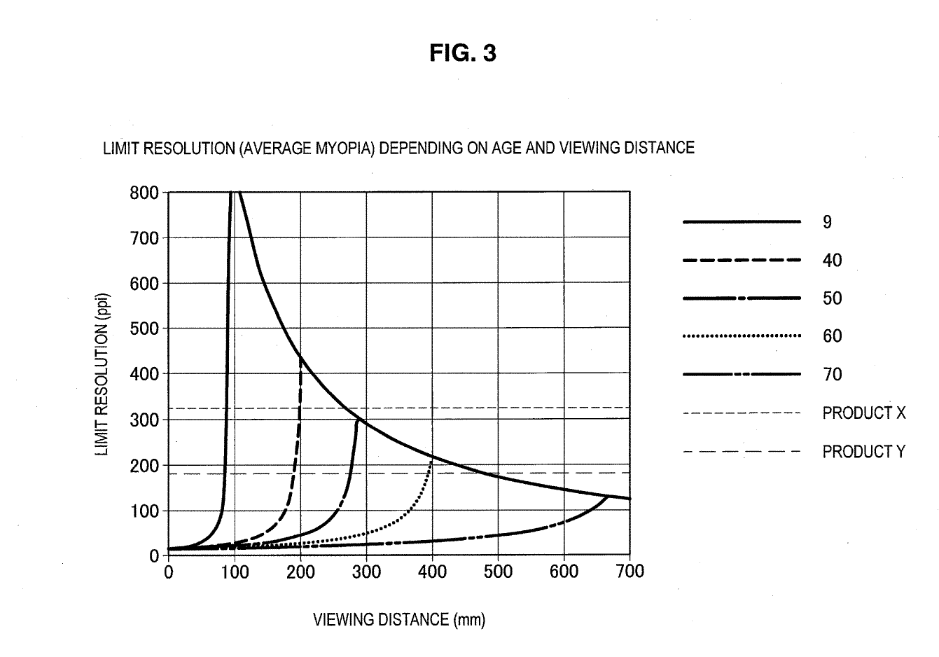

A user with presbyopia is considered with reference to FIGS. 2 and 3. FIG. 2 illustrates an example in which relationships between a limit resolution of a user with emmetropia with a far-field visual acuity of 1.0 and an age and a viewing distance are approximated. In FIG. 2, the viewing distance (mm) is taken on the horizontal axis, the limit resolution (ppi) of a user with general emmetropia is taken on the vertical axis, and a relationship between the two is plotted. Also, when the age is taken as a parameter and the age is 9 years old, 40 years old, 50 years old, 60 years old, and 70 years old, the relationship between the viewing distance and the limit resolution is plotted.

Also, an example in which relationships between the limit resolution of a user having standard myopia to the extent that a lens of −1.0 (diopter) is appropriate for far-field vision and an age and a viewing distance are approximated is illustrated in FIG. 3. FIG. 3 is a graph illustrating an example in which relationships between a limit resolution of a user with myopia and an age and a viewing distance are approximated. In FIG. 3, the viewing distance (mm) is taken on the horizontal axis, the limit resolution (ppi) of a general myopia user is taken on the vertical axis, and the relationship between the two is plotted. Also, when the age is taken as a parameter and the age is 9 years old, 40 years old, 50 years old, 60 years old, and 70 years old, a relationship between the viewing distance and the limit resolution is plotted.

Referring to FIGS. 2 and 3, it can be seen that the limiting resolution decreases with the age with respect to both the user with emmetropia and the user with myopia. This is due to presbyopia progressing with aging. In FIGS. 2 and 3, together with the resolution of the product X illustrated in FIG. 1, the resolution of another product Y is also shown. The resolution of the product Y is about 180 (ppi) (indicated by a different type of broken line from that for the product X in FIGS. 2 and 3).

From FIG. 2, it can be seen that the resolution of the product X cannot be substantially distinguished by a user of 40 years old or more having emmetropia. Also, referring to FIG. 3, it can be seen that, although the decrease of the limit resolution in accordance with aging is gentle for a user with myopia compared to a user with emmetropia, the resolution of the product X cannot be substantially distinguished for users of 50 years old or more.

Here, referring to FIGS. 2 and 3, if the viewing distance is around 250 (mm), for example, for a user of 40 years old, there is a possibility of their limit resolution exceeding the resolution of product X and it being possible to distinguish the resolution of product X. However, the range of the viewing distance where the limit resolution exceeds the resolution of product X is extremely limited. The limit resolution decreases due to presbyopia when the viewing distance becomes closer and the limit resolution decreases due to a limit of visual acuity in accordance with a distance to the display surface when the viewing distance becomes farther away. It is not desirable for the user to visually recognize the display surface in a state in which the viewing distance is always kept within the range in terms of comfortable use.

As described above, for a user with presbyopia of, for example, 40 years old or more, it is difficult to say that the resolution enhancement of about 300 (ppi) or more is meaningful from a viewpoint of the benefit to the user. However, despite the fact that the amount of information handled by users has increased in recent years, devices handled by users like mobile devices have tended to become miniaturized. Accordingly, it is an inevitable requirement to increase an information density in the display screen in, for example, mobile devices such as smart phones and wearable devices.

As a method of improving the visibility for the user, it is conceivable to decrease the density of the information on the display screen, such as increasing a character size of the display screen. However, this method is contrary to a demand for higher density of information. Also, if the density of the information on the display screen decreases, the amount of information given to the user on one screen decreases and the usability for the user also decreases. Alternatively, it is conceivable to increase the amount of information on one screen by increasing the size of the display screen itself, but, in that case, portability, which is an advantage of the mobile device, deteriorates.

While there is a demand to provide a high-resolution display screen having a larger information density amount for all users including the elderly as described above, there is a limit due to the user's visual acuity in the resolution capable of being distinguished by the user.

Here, as described above, in general, optical compensation instruments such as presbyopic glasses are widely used as a countermeasure against presbyopia. However, presbyopic glasses need to be attached and detached in accordance with the distance to an observation object. In accordance with this, it is necessary to carry tools for storing presbyopic glasses such as eyeglass cases. It is necessary for users using mobile devices to carry tools with a volume equal to or larger than that of the mobile device, which feels annoying to many users. Further, many users feel resistance to wearing presbyopic glasses themselves.

In view of the above circumstances, there has been a demand for technology capable of providing favorable visibility for a user in which high-resolution display is able to be distinguished without using additional instruments such as presbyopic glasses. The present inventors have conceived the following embodiments of the present disclosure as a result of diligently studying technology capable of providing favorable visibility for a user by devising the configuration of a display device without using additional instruments such as presbyopic glasses.

Hereinafter, the first and second embodiments conceived by the present inventors as preferred embodiments of the present disclosure will be described.

### 2. First Embodiment

### 2-1. Basic Principle of First Embodiment

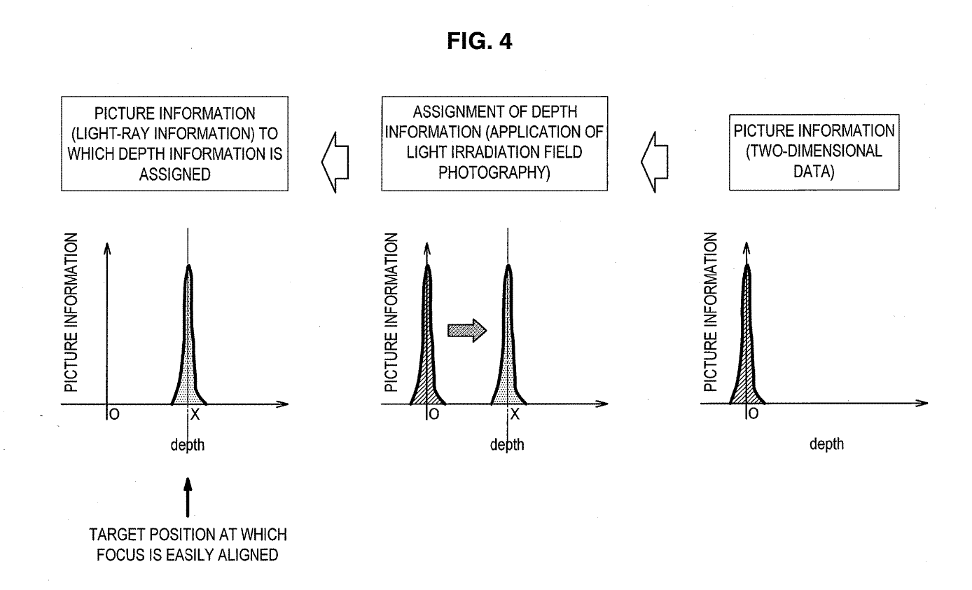

First, prior to describing a specific device configuration, the basic principle of the first embodiment will be described with reference to FIG. 4. FIG. 4 is an explanatory diagram illustrating a concept of assigning depth information to two-dimensional picture information.

As illustrated in the right diagram of FIG. 4, in a general display device, picture information is displayed as a two-dimensional picture on the display surface. Two-dimensional picture information can be said to be picture information without depth information.

Here, there is technology called irradiation field photography as photographic technology capable of obtaining pictures at various focal positions through calculation by acquiring information about both a position and a direction of light rays in a space of a subject without obtaining information about the intensity of light incident from each direction as in a normal photographing device when the subject is photographed. This technology can be implemented by performing a process of simulating a state of image formation within a camera through calculation on the basis of a light-ray state within the space (light field).

On the other hand, as technology for reproducing information of the light-ray state (light field) in a real space, technology called light-ray reproduction technology is also known. In the example illustrated in FIG. 4, the light-ray state in a case in which the display surface is present at the position X is first obtained through calculation, and the obtained light-ray state is reproduced by the light-ray reproduction technology, so that a real display surface is located at a position O, but it is possible to reproduce the light-ray state as if the display surface were located at a position X different from the position O (see the middle drawing in FIG. 4). Information of the light-ray state (light-ray information) can also be said to be three-dimensional picture information in which information about the position in a depth direction of a virtual display surface is assigned to two-dimensional picture information.

By reproducing a light-ray state as if the display surface were located at the position X in accordance with the light-ray information and irradiating the user's pupil with light in the irradiation state based on the light-ray state, the user visually recognizes an image on a virtual display surface (that is, a virtual image) located at the position X. If the position X is adjusted to a position in focus for, for example, a user with presbyopia, it is possible to provide an in-focus picture to the user.

As such a display device for reproducing a predetermined light-ray state on the basis of light-ray information, several light-ray reproduction type display devices are known. The light-ray reproduction type display device is configured so that light from each pixel can be controlled in accordance with an emission direction, and is widely used as, for example, a naked-eye 3D display device that provides 3D pictures by emitting light so that a picture taking into consideration binocular parallax on left and right eyes of the user is recognized.

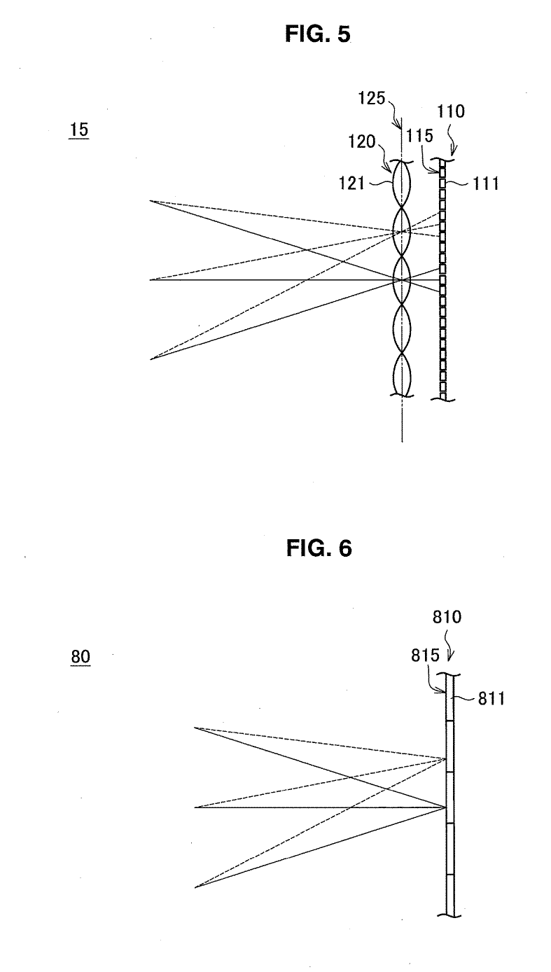

An example of the configuration of the light-ray reproduction type display device is illustrated in FIG. 5. FIG. 5 is a diagram illustrating an example of the configuration of the light-ray reproduction type display device. Also, for comparison, an example of a configuration of a display device that displays a general two-dimensional picture is illustrated in FIG. 6. FIG. 6 is a diagram illustrating an example of a configuration of a display device that displays a general two-dimensional picture.

Referring to FIG. 6, a display surface of a general display device 80 includes a pixel array 810 in which a plurality of pixels 811 are two-dimensionally arranged. In FIG. 6, for convenience, the pixel array 810 is illustrated as if the pixels 811 were arranged in one column, but, in reality, the pixels 811 are arranged also in the depth direction of the drawing sheet. The amount of light from each pixel 811 is not controlled depending on the emission direction, and a controlled amount of light is similarly emitted in any direction. The two-dimensional picture described with reference to the drawing on the right side of FIG. 4 indicates, for example, a two-dimensional picture displayed on the display surface 815 of the pixel array 810 illustrated in FIG. 6. Hereinafter, in order to distinguish it from the light-ray reproduction type display device, a display device 80 for displaying a two-dimensional picture (that is, picture information without depth information) as represented in FIG. 6 is also referred to as a two-dimensional display device 80.

Referring to FIG. 5, a light-ray reproduction type display device 15 includes a pixel array 110 in which a plurality of pixels 111 are two-dimensionally arranged and a microlens array 120 provided on a display surface 115 of the pixel array 110. In FIG. 5, for convenience, the pixel array 110 is illustrated as if the pixels 111 were arranged in one column, but the pixels 111 are also actually arranged in a depth direction of the drawing sheet. Likewise, also in the microlens array 120, the microlenses 121 are actually arranged in the depth direction of the drawing sheet. Because the light from each pixel 111 is emitted through the microlens 121, the lens surface 125 of the microlens array 120 becomes an apparent display surface 125 in the light-ray reproduction type display device 15.

A pitch of the microlenses 121 in the microlens array 120 is configured to be larger than the pitch of the pixels 111 in the pixel array 110. That is, a plurality of pixels 111 are located immediately below one microlens 121. Accordingly, light from the plurality of pixels 111 is incident on one microlens 121, and is emitted with directivity. Consequently, by appropriately controlling the driving of each pixel 111, it is possible to adjust a direction, a wavelength, an intensity, etc. of the light emitted from each microlens 121.

In this manner, in the light-ray reproduction type display device 15, each microlens 121 constitutes a light emission point, and the light emitted from each light emission point is controlled by a plurality of pixels 111 provided immediately below each microlens 121. By driving each pixel 111 on the basis of the light-ray information, the light emitted from each light emission point is controlled and a desired light-ray state is implemented.

Specifically, in the example illustrated in, for example, FIG. 4, the light-ray information includes information about an emission state of light (a direction, a wavelength, an intensity, etc. of emitted light) in each microlens 121 for observing an image (that is, a virtual image) on a virtual display surface located at the position X different from the position O when the real display surface located at the position O (corresponding to the display surface 125 of the microlens array 120 illustrated in FIG. 5) is viewed. Each pixel 111 is driven on the basis of the light-ray information and light whose emission state is controlled is emitted from each microlens 121, so that the user's pupil is irradiated with light for observing a virtual image at the position X for the user located at the observation position. It can also be said that controlling the emission state of light on the basis of the light-ray information is controlling the irradiation state of light for the user's pupil.

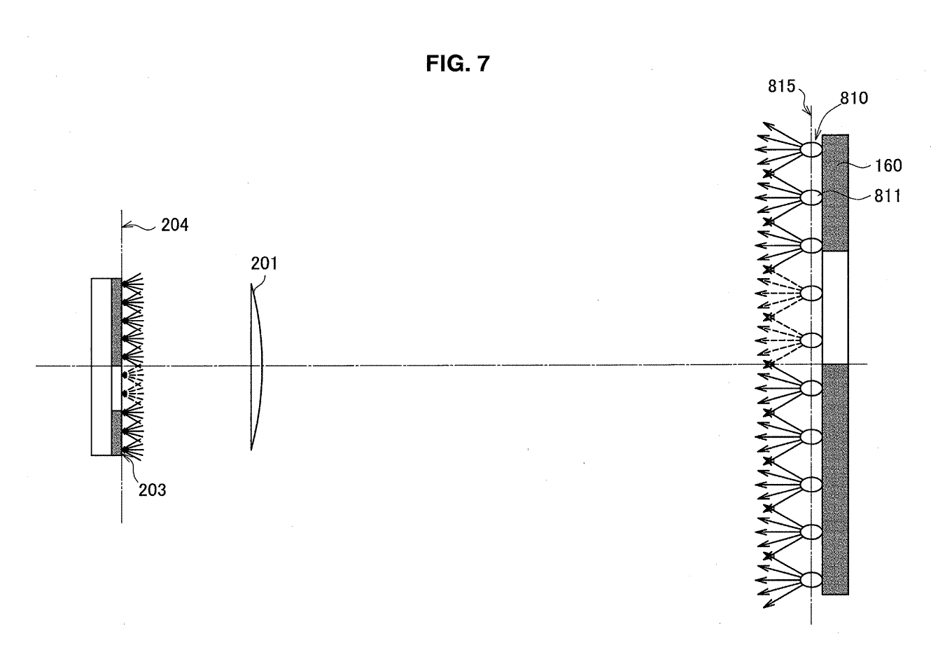

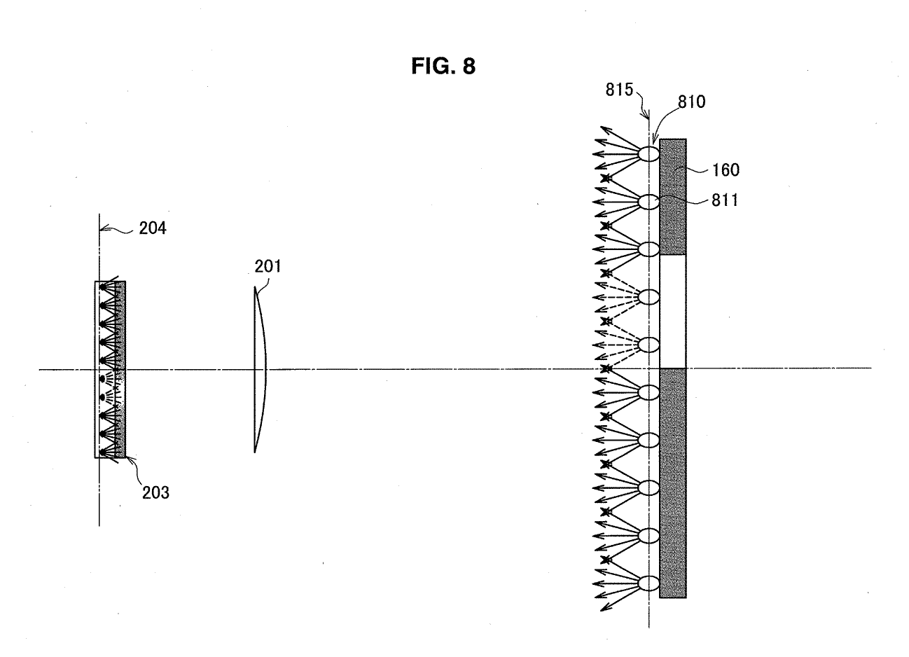

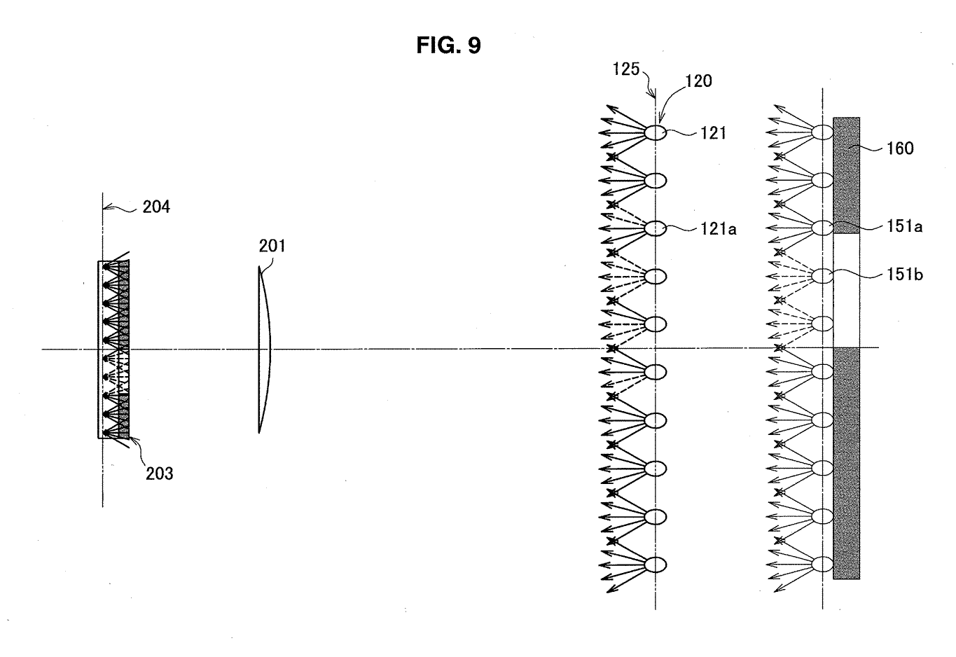

The above-described details including the state of image formation on the retina of the user will be described in more detail with reference to FIGS. 7 to 9. FIG. 7 is a schematic diagram illustrating a state in which the user's focus is aligned with the display surface in the general two-dimensional display device 80. FIG. 8 is a schematic diagram illustrating a state in which the user's focus is not aligned with the display surface in the general two-dimensional display device 80. FIG. 9 is a schematic diagram illustrating a relationship between a virtual image surface in the light-ray reproduction type display device 15 and an image formation surface on the user's retina. In FIGS. 7 to 9, the pixel array 810 and the display surface 815 of the general two-dimensional display device 80 or the microlens array 120 and the display surface 125 of the light-ray reproduction type display device 15 and a lens 201 (a crystalline lens 201) and a retina 203 of an eye of the user are schematically illustrated.

Referring to FIG. 7, a state in which a picture 160 is displayed on the display surface 815 is schematically illustrated. In the general two-dimensional display device 80, in a state in which the user's focus is aligned with the display surface 815, light from each pixel 811 of the pixel array 810 passes through the lens 201 of the user's eye and an image thereof is formed on the retina 203 (that is, the image formation surface 204 is located on the retina 203). Arrows drawn with different line types in FIG. 7 indicate light of different wavelengths emitted from the pixels 811, that is, light of different colors.

In FIG. 8, a state in which the display surface 815 is located closer to the user than in the state illustrated in FIG. 7 and the user's focus is not aligned with the display surface 815 is illustrated. Referring to FIG. 8, light from each pixel 811 of the pixel array 810 does not form an image on the user's retina 203 and the image formation surface 204 is located behind the retina 203. In this case, a blurred picture out of focus is recognized by the user. FIG. 8 illustrates a state in which a user having presbyopia views a blurred picture in an attempt to view a nearby display surface.

FIG. 9 illustrates a light-ray state when the light-ray reproduction type display device 15 is driven such that it displays a picture 160 on the virtual image surface 150 as a virtual image for the user. In FIG. 9, similar to the display surface 815 illustrated in FIG. 8, the display surface 125 is located relatively close to the user. The virtual image surface 150 is set as a virtual display surface located farther away than the real display surface 125.

Here, as described above, in the light-ray reproduction type display device 15, an emission state of light can be controlled so that microlenses 121 (that is, light emission points 121) emit light of mutually different light intensities and/or wavelengths in mutually different directions instead of isotropically emitting unique light. For example, the light emitted from each microlens 121 is controlled so that the light from the picture 160 on the virtual image surface 150 is reproduced. Specifically, for example, assuming virtual pixels 151 (151a and 151b) on the virtual image surface 150, it can be considered that light of a first wavelength is emitted from a certain virtual pixel 151a and light of a second wavelength is emitted from the other virtual pixel 151b in order to display the picture 160 on the virtual image surface 150. In accordance with this, the emission state of the light is controlled so that the microlens 121a emits the light of the first wavelength in the direction corresponding to the light from the pixel 151a and emits the light of the second wavelength in the direction corresponding to the light from the pixel 151b. Although not illustrated, a pixel array is actually provided on the back side (the right side of the drawing sheet in FIG. 9) of the microlens array 120 as illustrated in FIG. 5 and driving of each pixel of the pixel array is controlled, so that the emission state of light from the microlens 121a is controlled.

Here, the distance from the retina 203 of the virtual image surface 150 is set to a position in focus for the user, for example, a position of the display surface 815 illustrated in FIG. 7. The light-ray reproduction type display device 15 is driven such that it reproduces the light from the picture 160 on the virtual image surface 150 located at such a position, so that the image formation surface 204 of the light from the real display surface 125 is located behind the retina 203, but an image of the picture 160 on the virtual image surface 150 is formed on the retina 203. Accordingly, in terms of a user having presbyopia, even when the distance between the user and the display surface 125 is short, the user can view a favorable picture 160 similar to that in a distant view.

The basic principle of the first embodiment has been described above. As described above, in the first embodiment, by using the light-ray reproduction type display device, the light from the picture 160 on the virtual image surface 150 which is set at a position in focus for a user with presbyopia is reproduced and the light is emitted to the user. This allows the user to observe the in-focus picture 160 on the virtual image surface 150. Accordingly, for example, even when the picture 160 is a high-resolution picture in which the resolution at the viewing distance on the real display surface 125 exceeds the limit resolution of the user, the in-focus picture is provided to the user without using additional optical compensation instruments such as presbyopic glasses and a fine picture 160 can be observed. Consequently, even when the density of information is increased in a comparatively small display screen as described in the above (1. Background of present disclosure), the user can favorably observe a picture on which high-density information is displayed by supplementing the visual acuity of the user. Also, according to the first embodiment, because it is possible to perform display in which visual acuity compensation is performed without using optical compensation instruments such as presbyopic glasses as described above, it is unnecessary to carry additional portable items such as presbyopic glasses themselves and/or a glasses case for storing presbyopic glasses and the burden on the user is decreased.

Also, although a case in which the virtual image surface 150 is set to be farther away than the real display surface 125 as illustrated in FIG. 9 to compensate for the visual acuity for the user with presbyopia has been described above, the first embodiment is not limited to such an example. For example, the virtual image surface 150 may be set to be closer than the real display surface 125. In this case, the virtual image surface 150 is set at a position in focus for, for example, a user with myopia. Thereby, the user with myopia can observe the in-focus picture 160 without using optical compensation instruments such as eyeglasses and contact lenses. Switching of display between visual acuity compensation for a user with presbyopia and visual acuity compensation for a user with myopia can be freely implemented simply by changing data displayed on each pixel and it is unnecessary to change a hardware mechanism.

### 2-2. Display Device According to First Embodiment

A detailed configuration of the display device according to the first embodiment capable of implementing an operation based on the basic principle described above will be described.

### (2-2-1. Device Configuration)

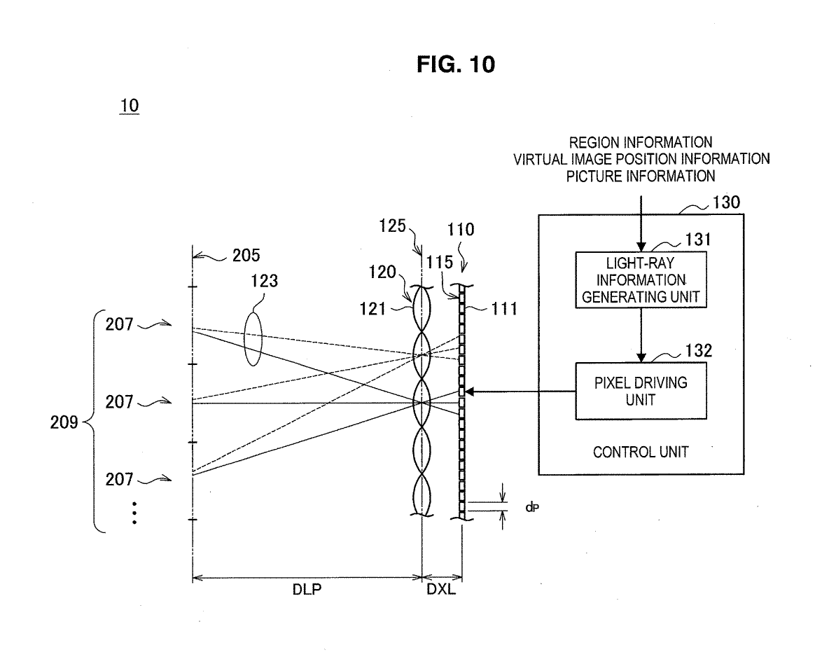

The configuration of the display device according to the first embodiment will be described with reference to FIG. 10. FIG. 10 is a diagram illustrating an example of the configuration of the display device according to the first embodiment.

Referring to FIG. 10, the display device 10 according to the first embodiment includes a pixel array 110 in which a plurality of pixels 111 are two-dimensionally arranged, a microlens array 120 provided on the display surface 115 of the pixel array 110, and a control unit 130 that controls driving of each pixel 111 of the pixel array 110. Here, the pixel array 110 and the microlens array 120 illustrated in FIG. 10 are similar to those illustrated in FIG. 5. Also, the control unit 130 drives each pixel 111 such that it reproduces a predetermined light-ray state on the basis of the light-ray information. In this manner, the display device 10 can be configured as a light-ray reproduction display device.

As in the light-ray reproduction type display device 15 described with reference to FIG. 5, the pitch of the microlenses 121 in the microlens array 120 is configured to be larger than the pitch of the pixels 111 in the pixel array 110 and light from a plurality of pixels 111 is incident on one microlens 121 and is emitted with directivity. As described above, in the display device 10, each microlens 121 constitutes a light emission point. The microlens 121 corresponds to a pixel in a general two-dimensional display device, and the lens surface 125 of the microlens array 120 becomes an apparent display surface 125 in the display device 10.

The pixel array 110 may include a liquid crystal layer (liquid crystal panel) of a liquid crystal display device having, for example, a pixel pitch of about 10 (μm). Although not illustrated, various structures provided for the pixels in general liquid crystal display devices such as a driving element for driving each pixel of the pixel array 110 and a light source (backlight) may be connected to the pixel array 110. However, the first embodiment is not limited to this example and another display device such as an organic EL display device or the like may be used as the pixel array 110. Also, the pixel pitch is not limited to the above example and may be appropriately designed in consideration of the resolution etc. desired to be implemented.

The microlens array 120 is configured by two-dimensionally arranging convex lenses having, for example, a focal length of 3.5 (mm), in a lattice form with a pitch of 0.15 (mm). The microlens array 120 is provided to substantially cover the entire pixel array 110. A distance between the pixel array 110 and the microlens array 120 is set to be longer than the focal length of each microlens 121 of the microlens array 120 and the pixel array 110 and the microlens array 120 are configured to be at positions at which an image on the display surface 115 of the pixel array 110 is approximately formed on a plane substantially parallel to the display surface 115 (or the display surface 125) including the user's pupil. Generally, the image formation position of the picture on the display surface 115 can be preset as an observation position assumed when the user observes the display surface 115. However, the focal length and the pitch of the microlenses 121 in the microlens array 120 are not limited to the above-described example, and may be appropriately designed on the basis of an arrangement relationship with other members, the image formation position of the picture on the display surface 115 (that is, an assumed observation position of the user), or the like.

The control unit 130 includes a processor such as a central processing unit (CPU) or a digital signal processor (DSP) and operates in accordance with a predetermined program, thereby controlling the driving of each pixel 111 of the pixel array 110. The control unit 130 has a light-ray information generating unit 131 and a pixel driving unit 132 as its functions.

The light-ray information generating unit 131 generates light-ray information on the basis of region information, virtual image position information, and picture information. Here, the region information is information about a region group including a plurality of regions which are set on a plane including the user's pupil and substantially parallel to the display surface 125 of the microlens array 120 and which are smaller than the pupil diameter of the user. The region information includes information about a distance between the plane on which the region is set and the display surface 125, information about a size of the region, and the like.

In FIG. 10, a plane 205 including the pupil of the user, a plurality of regions 207 set on the plane 205, and a region group 209 are simply illustrated. The plurality of regions 207 are set to be located in the pupil of the user. The region group 209 is set in a range in which light emitted from each microlens 121 can reach the plane 205. In other words, the microlens array 120 is configured so that the region group 209 is irradiated with the light emitted from one microlens 121.

Here, in the first embodiment, the wavelength, the intensity, and the like of light emitted from each microlens 121 are adjusted in accordance with the combination of the microlens 121 and the region 207. That is, for each region 207, the irradiation state of light incident on the region 207 is controlled. The region 207 corresponds to a size in which light from one pixel 111 is projected onto the pupil (a projection size of light from the pixel 111 on the pupil) and an interval between the regions 207 can be said to indicate a sampling interval when light is incident on the pupil of the user. In the following description, the region 207 is also referred to as a sampling region 207. The region group 209 is also referred to as a sampling region group 209.

The virtual image position information is information about a position at which a virtual image is generated (a virtual image generation position). The virtual image generation position is the position of the virtual image surface 150 illustrated in FIG. 9. The virtual image position information includes information about the distance from the display surface 125 to the virtual image generation position. Also, the picture information is two-dimensional picture information presented to the user.

On the basis of the region information, the virtual image position information, and the picture information, the light-ray information generating unit 131 generates light-ray information indicating the light-ray state for light from the picture to be incident on each sampling region 207 based on the region information when the picture based on the picture information is displayed at the virtual image generation position based on the virtual image position information. The light-ray information includes information about the emission state of light in each microlens 121 and information about the irradiation state of the light for each sampling region 207 for reproducing the light-ray state. A process to be performed by the light-ray information generating unit 131 corresponds to a process of assigning depth information to the two-dimensional picture information described with reference to FIG. 4 in the above (2-1. Basic principle of first embodiment).

Also, the picture information may be transmitted from another device or may be pre-stored in a storage device (not shown) provided in the display device 10. The picture information may be information about pictures, text, graphs, and the like which represent results of various processes executed by a general information processing device.

Also, the virtual image position information may be input in advance by, for example, the user, a designer of the display device 10, or the like, and stored in the above-described storage device. Also, in the virtual image position information, the virtual image generation position is set to be a position in focus for the user. For example, a general focus position that is suitable for a relatively large number of users having presbyopia may be set as a virtual image generation position by the designer of the display device 10 or the like. Alternatively, the virtual image generation position may be appropriately adjusted in accordance with the user's visual acuity by the user, and the virtual image position information within the above-described storage device may be updated each time.

Also, the region information may be input in advance by, for example, the user, the designer of the display device 10, or the like, and may be stored in the above-described storage device. Here, the distance between the display surface 125 and a plane 205 on which the sampling region 207 is set (the plane 205 corresponds to the observation position of the user) included in the region information may be set on the basis of a position at which the user is assumed to generally observe the display device 10. For example, if a device equipped with the display device 10 is a wristwatch type wearable device, the above-described distance can be set in consideration of a distance between the user's pupil and an arm that is an attachment position of the wearable device. Also, for example, if the device equipped with the display device 10 is a stationary type television installed in a room, the above-described distance can be set in consideration of a general distance between a television and a user's pupil when the television is watched. Alternatively, the above-described distance may be appropriately adjusted by the user in accordance with a usage mode, and the virtual image position information in the storage device may be updated each time. Also, the size of the sampling region 207 included in the region information can be appropriately set in consideration of matters to be described in the following (2-2-3-1. Sampling region).

The light-ray information generating unit 131 provides the generated light-ray information to the pixel driving unit 132.

The pixel driving unit 132 drives each pixel 111 of the pixel array 110 such that it reproduces the light-ray state when a picture based on the picture information is displayed on the virtual image surface on the basis of the light-ray information. At this time, the pixel driving unit 132 drives each pixel 111 so that the light emitted from each microlens 121 is controlled independently for each sampling region 207. Thereby, as described above, the irradiation state of light incident on the sampling region 207 is controlled for each sampling region 207. For example, in the example illustrated in FIG. 10, a state in which light 123 configured by superimposing light from a plurality of pixels 111 is incident on each sampling region 207 is illustrated.

Here, the projection size of the light 123 on the pupil (on the plane 205) needs to be equal to or less than the size of the sampling region 207 in order to cause the light 123 to be incident on the sampling region 207. Accordingly, in the display device 10, the structure, arrangement, and the like of each member are designed so that the projection size of the light 123 on the pupil is equal to or smaller than the size of the sampling region 207.

On the other hand, as will be described in detail in the following (2-2-3-1. Sampling region), an amount of blur of the image on the retina of the user depends upon the projection size of the light 123 on the pupil (that is, an entrance pupil diameter of light). If the amount of blur on the retina is larger than the size on the retina of an image capable of being distinguished by the user, a blurred image will be recognized by the user. When an adjustment function of the eye is insufficient due to presbyopia or the like, the projection size of the light 123 on the pupil corresponding to the size of the sampling region 207 needs to be sufficiently smaller than the pupil diameter in order to make the amount of blur on the retina equal to or smaller than the size on the retina of an image capable of being distinguished by the user.

Specifically, whereas the general human pupil diameter is about 2 (mm) to 8 (mm), it is preferable to set the size of the sampling region 207 to about 0.6 (mm) or less. Conditions required for the size of the sampling region 207 will be described in detail again in the following (2-2-3-1. Sampling region).

Here, as is apparent from FIG. 10, the projection size of the light 123 on the pupil depends on an image magnification and a size dp of the pixel 111 of the pixel array 110. Here, the image magnification is a ratio between a viewing distance (a distance between the lens surface 125 of the microlens array 120 and the pupil) DLP and a lens inter-pixel distance (a distance between the lens surface 125 of the microlens array 120 and the display surface 115 of the pixel array 110) DXL (DLP/DXL). Accordingly, in the first embodiment, the size dp of the pixel 111, the arrangement positions of the microlens array 120 and the pixel array 110, and the like may be appropriately designed so that the projection size of the light 123 on the pupil is sufficiently smaller than the pupil diameter (in more detail, about 0.6 (mm) or less) in consideration of a distance (that is, DLP) at which the user is assumed to generally observe the display surface 125.

Also, in the display device 10, the arrangement of each constituent member is set so that the irradiation state of light with respect to each sampling region 207 is periodically iterated in units larger than the maximum pupil diameter of the user. This is for displaying a picture similar to that before a movement to a user even at a position after a movement of the user's pupil position when the position of the pupil of the user has moved. The iteration cycle is determined by the pitch of the microlenses 121 of the microlens array 120, DXL, and DLP. Specifically, iteration cycle=(pitch of microlens 121)×(DLP+DXL)/DXL. On the basis of this relationship, the pitch of the microlenses 121, the size dp and the pitch of the pixels 111 in the pixel array 110, and values such as DXL and DLP are set so that the iteration cycle satisfies the above-described conditions. The conditions required for the iteration cycle will be described in detail again in the following (2-2-3-2. Iteration cycle of irradiation state of sampling region).

As described above, the configuration of the display device 10 according to the first embodiment has been described with reference to FIG. 10.

Here, the display device 10 according to the first embodiment is similar to a light-ray reproduction type display device widely used as a naked-eye 3D display device in terms of a partial configuration. However, because an objective of the naked-eye 3D display device is to display a picture having binocular parallax with respect to the left and right eyes of the user, the emission state of emitted light is controlled only in the horizontal direction and the control of the emission state is not performed in the vertical direction in many cases. Accordingly, for example, in many cases, a configuration in which a lenticular lens is provided on the display surface of the pixel array is provided. On the other hand, because an objective of the display device 10 according to the first embodiment is to display a virtual image for the purpose of compensating for the eye adjustment function for the user, the control of the emission state is naturally performed in both directions of the horizontal direction and the vertical direction. Thus, instead of the lenticular lens as described above, the microlens array 120 in which the microlenses 121 are two-dimensionally arranged is used on the display surface of the pixel array.

Also, because an objective of the naked-eye 3D display device is to display a picture having binocular parallax with respect to the left and right eyes of the user as described above, the sampling region 207 described in the first embodiment is set as a relatively large region including the whole eye of the user. Specifically, the size of the sampling region 207 is set to about 65 (mm), which is the average value of a user's pupil distance (PD), or about a fraction thereof in many cases. On the other hand, in the first embodiment, the size of the sampling region 207 is set to be smaller than the pupil diameter of the user, in more detail, smaller than about 0.6 (mm). As described above, because the purpose and the field of application are different, a structure different from that of a general naked eye 3D display device is adopted and different drive control is performed in the display device 10 according to the first embodiment.

### (2-2-2. Driving Example)

Next, a specific driving example in the display device 10 illustrated in FIG. 10 will be described. The display device 10 according to the first embodiment can be driven in a mode in which a virtual image on a virtual display surface different from the real display surface 125 is displayed (that is, picture information to which depth information is assigned is displayed) (hereinafter also referred to as a visual acuity compensation mode) or a mode in which two-dimensional picture information is displayed (hereinafter also referred to as a normal mode). Because the virtual image is visually recognized by a user in the visual acuity compensation mode, it is possible to provide a favorable picture even for a user for which it is difficult to align a focus on the real display surface 125 due to presbyopia or myopia. On the other hand, in the normal mode, it is possible to display, for example, a two-dimensional picture similar to that of the general two-dimensional display device 80 illustrated in FIG. 6, with the configuration of the display device 10 illustrated in FIG. 10.

### (2-2-2-1. Normal Mode)

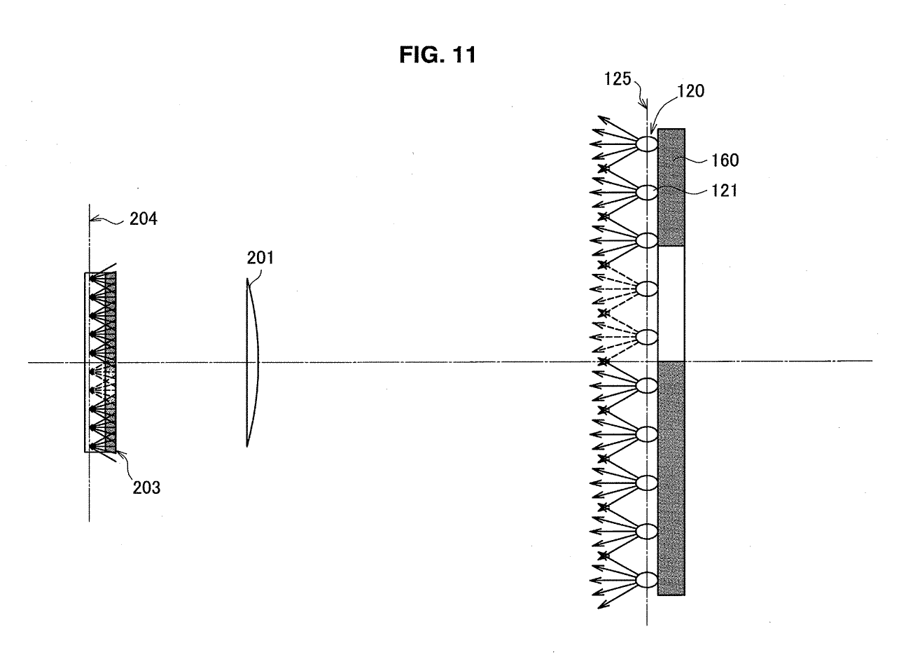

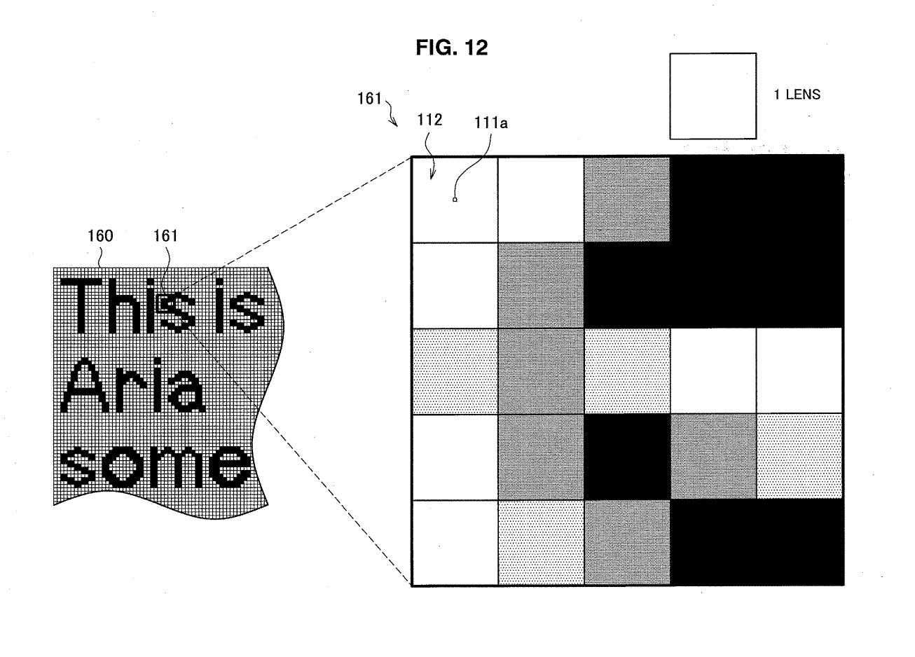

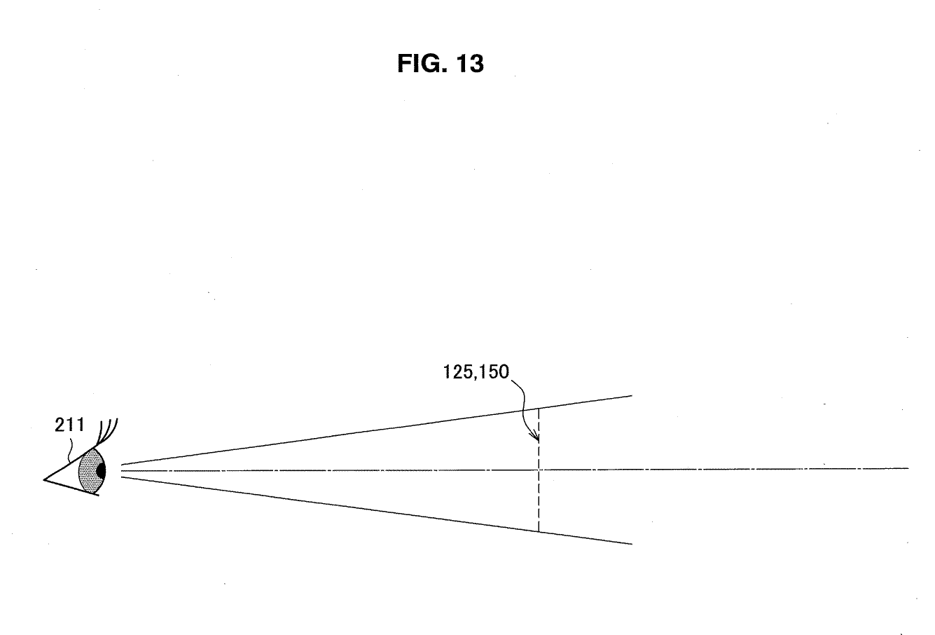

Driving of the display device 10 in the normal mode will be described with reference to FIGS. 11 to 13. FIG. 11 is a diagram illustrating light rays emitted from the microlens 121 in the normal mode. FIG. 12 is a diagram illustrating a specific display example of the pixel array 110 in the normal mode. FIG. 13 is a diagram illustrating a positional relationship between the virtual image surface 150 and the display surface 125 of the microlens array 120 in the normal mode.

Referring to FIG. 11, as in FIG. 9, the microlens array 120 and the display surface 125 thereof, the user's eye lens 201, and the user's retina 203 are schematically illustrated. Also, the picture 160 displayed on the display surface 125 is schematically illustrated. Also, FIG. 11 corresponds to an example in which the picture 160 reproduced by the pixel array 810 in FIG. 8 described above is reproduced by a configuration similar to that in the first embodiment illustrated in FIG. 9. Accordingly, repeated description of matters already described with reference to FIG. 8 and FIG. 9 will be omitted.

As illustrated in FIG. 11, in the normal mode, the same light is emitted from each microlens 121 in directions of all emission angles. Thereby, each microlens 121 behaves as in each pixel 811 of the pixel array 810 illustrated in FIG. 8 and the picture 160 is displayed on the display surface 125 of the microlens array 120 by the microlens array 120.

FIG. 12 illustrates an example of a picture 160 that the user can actually visually recognize in the normal mode and a state in which a partial region of the pixel array 110 when the picture 160 is being displayed is enlarged. For example, as illustrated in FIG. 12, in the normal mode, the user is assumed to visually recognize the picture 160 including predetermined text data.

Here, the picture 160 in FIG. 12 is actually recognized by the user when the user sees the light from the pixel array 110 via the microlens array 120. An illustration obtained by enlarging a partial region 161 of the picture 160 and removing the microlens array 120 (that is, an illustration of the display of the pixel array 110 immediately below the region 161) is illustrated on the right side in FIG. 12. A pixel group 112 including a plurality of pixels 111 is located immediately below one microlens 121, but the same information is displayed in a pixel group 112 located immediately below one microlens 121 in the normal mode as illustrated on the right side of FIG. 12.

In this manner, each pixel 111 is driven so that the same information is displayed in the pixel group 112 immediately below each microlens 121 in the normal mode, so that two-dimensional picture information is displayed on the display surface 125 of the microlens array 120. The user can visually recognize a two-dimensional picture existing on the display surface 125 similar to the picture 160 provided in the general two-dimensional display device as illustrated in FIG. 8.

FIG. 13 illustrates relationships between the user's eye 211, the display surface 125 of the microlens array 120, and the virtual image surface 150. The normal mode corresponds to a state in which the virtual image surface 150 and the display surface 125 of the microlens array 120 coincide as illustrated in FIG. 13.

### (2-2-2-2. Visual Acuity Compensation Mode)

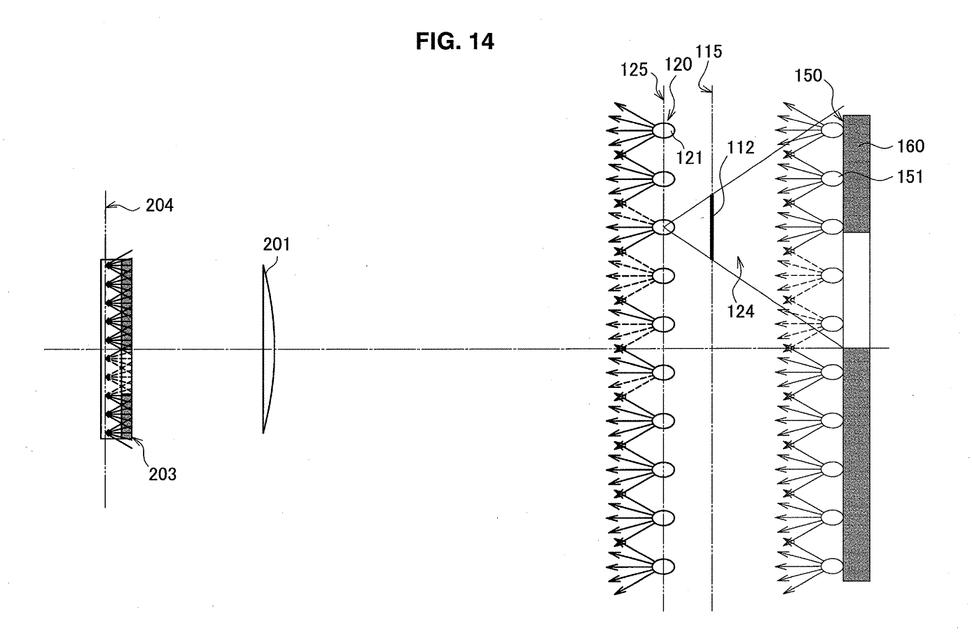

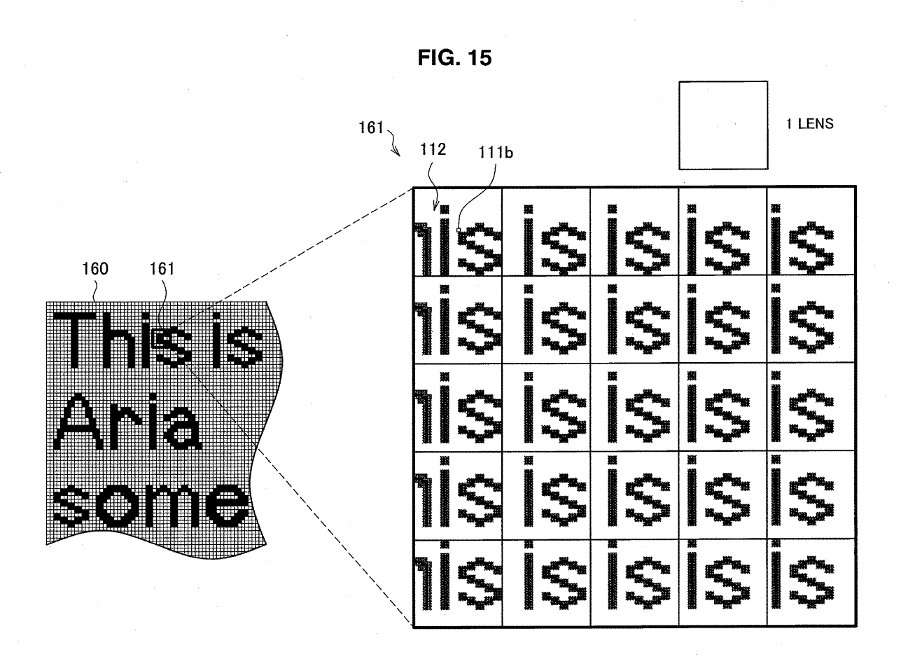

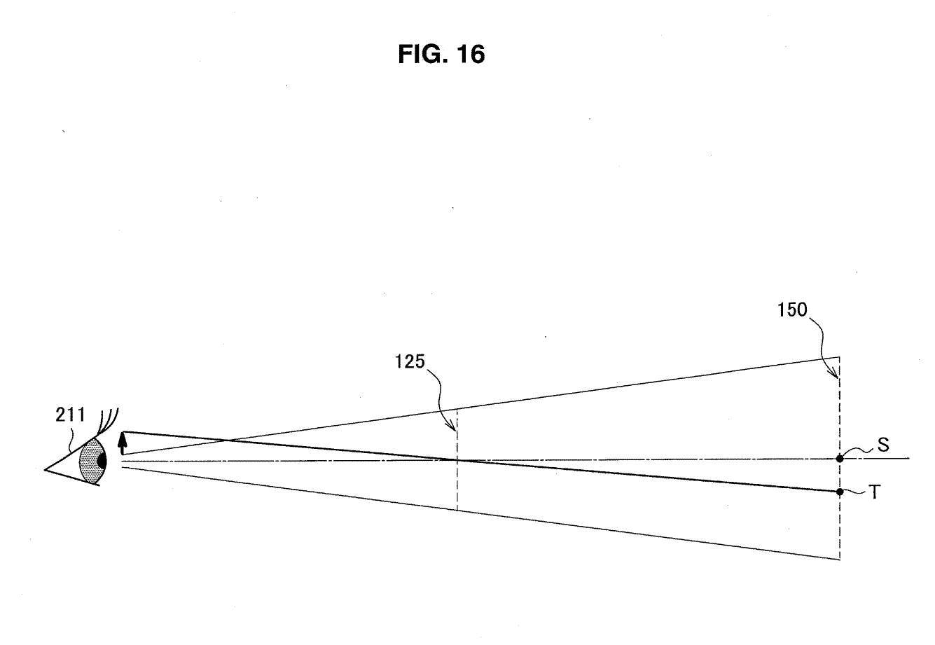

Next, the driving of the display device 10 in the visual acuity compensation mode will be described with reference to FIGS. 14 to 16. FIG. 14 is a diagram illustrating light rays emitted from the microlens 121 in the visual acuity compensation mode. FIG. 15 is a diagram illustrating a specific display example of the pixel array 110 in the visual acuity compensation mode. FIG. 16 is a diagram illustrating a positional relationship between the virtual image surface 150 and the display surface 125 of the microlens array 120 in the visual acuity compensation mode.

Referring to FIG. 14, as in FIG. 9, the microlens array 120 and the display surface 125 thereof, the virtual image surface 150, the virtual pixels 151 on the virtual image surface 150, the picture 160 on the virtual image surface, the lens 201 of the eye of the user, and the user's retina 203 are schematically illustrated. Also, in FIG. 14, the display surface 115 of the pixel array 110, which is not illustrated in FIG. 9, is also illustrated.

Also, FIG. 14 corresponds to an illustration obtained by adding the display surface 115 of the pixel array 110 to FIG. 9 described above. Accordingly, repeated description of matters already described with reference to FIG. 9 will be omitted.

In the visual acuity compensation mode, light is emitted from each microlens 121 to reproduce the light from the picture 160 on the virtual image surface 150. The picture 160 can be considered as a two-dimensional picture on the virtual image surface 150 displayed by the virtual pixels 151 on the virtual image surface 150. A range 124 of light that can be independently controlled in one certain microlens 121 is schematically illustrated in FIG. 14. The pixel group 112 (a part of the pixel array 110) immediately below the microlens 121 is driven such that the light from the virtual pixels 151 is reproduced on the virtual image surface 150 included in the range 124. Similar drive control is performed in each microlens 121, so that light is emitted from each microlens 121 to reproduce the light from the picture 160 on the virtual image surface 150.

An example of a picture 160 capable of being actually visually recognized by the user in the visual acuity compensation mode and a state in which a partial region of the pixel array 110 when the picture 160 is being displayed is enlarged are illustrated in FIG. 15. For example, as illustrated in FIG. 15, the user is assumed to visually recognize the picture 160 including predetermined text data. In the visual acuity compensation mode, the picture 160 is visually recognized by the user as a picture displayed on the virtual image surface 150 illustrated in FIG. 14.

Here, the picture 160 in FIG. 15 is actually recognized by the user when the user views the light from the pixel array 110 via the microlens array 120. An illustration obtained by enlarging a partial region 161 of the picture 160 and removing the microlens array 120 (that is, an illustration of the display of the pixel array 110 immediately below the region 161) is illustrated on the right side in FIG. 15.

A pixel group 112 including a plurality of pixels 111 is located immediately below one microlens 121. As illustrated in the drawing on the right side of FIG. 15, in the pixel group 112 located immediately below each microlens 121, the same information as in the normal mode is displayed in pixels located on an extension of the center of the microlens 121 when viewed from a certain point (that is, the same information is displayed on the pixel 111a illustrated in FIG. 12 and the pixel 111b illustrated in FIG. 15), but picture information that can be viewed through the movement of the viewpoint of the user is displayed around the pixels 111a and 111b.

Relationships between the user's eye 211, the display surface 125 of the microlens array 120, and the virtual image surface 150 are illustrated in FIG. 16. As illustrated in FIG. 16, in the visual acuity compensation mode, the virtual image surface 150 is located farther away than the display surface 125 by the microlens array 120. In FIG. 16, the movement of the viewpoint of the user is indicated by an arrow. In consideration of movement of the point visually recognized by the user on the virtual image surface 150 (movement from a point S to a point T in FIG. 16) corresponding to the movement of the user's viewpoint, picture information that can be viewed through the movement of the viewpoint is displayed on the pixel group 112 immediately below the microlens 121 as illustrated in FIG. 15. Each pixel 111 is driven as described above, so that the picture 160 is displayed to the user as if it were located on the virtual image surface 150.

Examples of driving in the normal mode and the visual acuity compensation mode have been described above as an example of driving in the display device 10.

### (2-2-3. Detailed Design)

A more detailed design method for each configuration in the display device 10 illustrated in FIG. 10 will be described. Here, conditions required for the size of the sampling region 207 illustrated in FIG. 10 and conditions required for the iteration cycle of the irradiation state of light for each sampling region 207 will be described.

### (2-2-3-1. Sampling Region)

As described above, it is preferable that the size of the sampling region 207 be sufficiently small with respect to the pupil diameter of the user so that a favorable image without blur is provided to the user. Hereinafter, the conditions required for the size of the sampling region 207 will be specifically examined.

For example, a level at which presbyopia can be first recognized is about 1 D (Diopter) as the strength of a necessary correction lens (presbyopic glasses). Here, if a Listing model obtained by modeling an average eyeball is used, the eyeball can be regarded to include a single lens of 60 D and a retina located at a distance of 22.22 (mm) from the single lens.

Light is incident on the retina via a lens of 60 D−1 D=59 D for the user wearing presbyopic glasses with an intensity of 1 D described above, so that the image formation surface can be formed at a position of 22.22×(60 D/59 D−1)≈0.38 (mm) behind the retina in the eyeball of the user. Also, in this case, when the entrance pupil diameter of light (corresponding to the projection size of the light 123 on the pupil illustrated in FIG. 10) is Ip, an amount of blur on the retina being Ip×0.38/22.22 (mm) can be obtained.

Here, when the visual acuity required for practical use is 0.5, the size of the image on the retina to be distinguished is about 0.0097 (mm) from the calculation shown in the following Equation (1). In the following Equation (1), 1.33 is a refractive index in the eyeball.

[Math. 1]

(1/(0.5×60))×(π/180)×22.22/1.33≈0.0097 (mm) (1)

If the amount of blur on the retina is smaller than the size of the image on the retina to be distinguished, the user can observe a clear image without blur. If Ip is obtained so that the above-described amount of blur on the retina (Ip×0.38/22.22 (mm)) is the size (0.0097 (mm)) of the image on the retina to be distinguished, Ip is about 0.6 (mm) from the following Equation (2).

[Math. 2]

Ip=0.0097×22.22/0.384≈0.6 (mm) (2)

When the degree of presbyopia is stronger, the distance of 0.38 (mm) between the retina and the image formation surface described above becomes longer, so that Ip becomes smaller from the above-described Equation (2). Also, when the required visual acuity is larger, a larger value is substituted for “0.5” in the above-described Equation (1), so that the size of the image on the retina to be distinguished is smaller than the above-described value (0.0097 (mm)) and Ip becomes smaller from the above-described Equation (2). Accordingly, it can be said that Ip≈0.6 (mm) calculated from the above-described Equation (2) substantially corresponds to a lower limit value required for an entrance pupil diameter of light.

In the first embodiment, because the light incident on each sampling region 207 is controlled, the size of the sampling region 207 is determined depending on the entrance pupil diameter of light. Accordingly, it can also be said that Ip≈0.6 (mm) calculated from the above-described Equation (2) is the lower limit value of the sampling region 207. As described above, in the first embodiment, the sampling region 207 is preferably set so that its size is 0.6 (mm) or less.

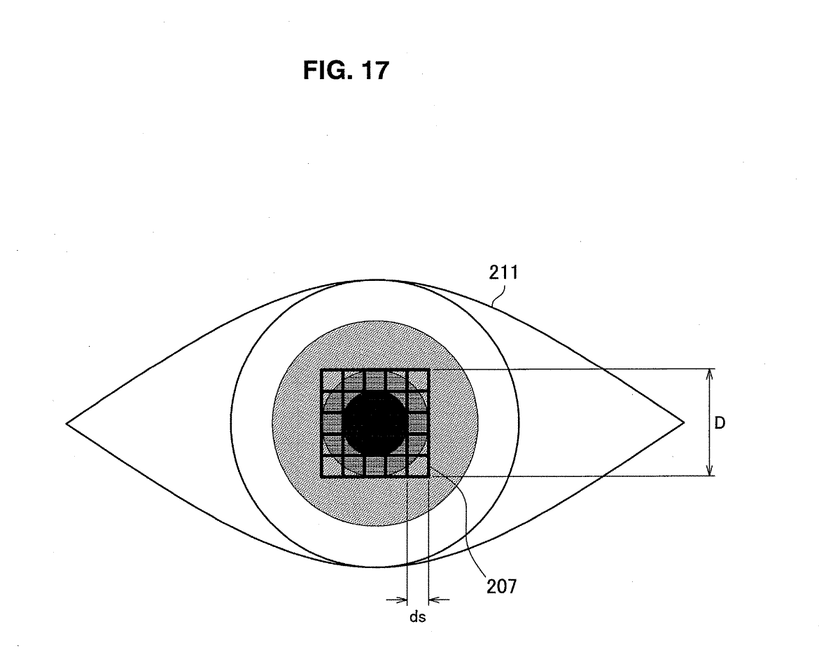

FIG. 17 is a diagram illustrating a relationship between the pupil diameter of the user's pupil and the size of the sampling region 207. In FIG. 17, the sampling region 207 set on the pupil of the user together with the user's eye 211 is schematically illustrated. A general human pupil diameter D is known to be about 2 (mm) to 8 (mm). On the other hand, as described above, a size ds of the sampling region 207 is preferably 0.6 (mm) or less. Accordingly, in the first embodiment, as illustrated in FIG. 17, a plurality of regions 207 are set in the pupil. Although a case in which the shape of the sampling region 207 is square has been described here, the shape of the sampling region 207 may be any of other various shapes such as a hexagon and a rectangle if the above-described conditions of the size are satisfied.

The conditions required for the size of the sampling region 207 have been described above.

Here, in the above-described Patent Literature 1, a configuration in which light from a plurality of pixels is emitted from each of a plurality of microlenses and projected onto the pupil of the user is also disclosed. However, in the technology described in Patent Literature 1, only one of projected images of light corresponding to pixels is incident on the user's pupil. This corresponds to the state in which only one sampling region 207 smaller than the pupil diameter is provided on the pupil at an interval equal to or larger than the pupil diameter in the first embodiment.

In the technology described in the above-described Patent Literature 1, blur is decreased by decreasing a size of a light beam incident on the pupil without performing a process of obtaining the light beam being incident on different points on the pupil through the virtual image generation process as in the first embodiment. Accordingly, when a plurality of light beams are incident on the pupil from the same lens, blur occurs in the image on the retina. Accordingly, in the technology described in the above-described Patent Literature 1, the interval of the light incident on the plane 205 including the pupil, that is, the interval at which the sampling regions 207 are provided is adjusted to be larger than the pupil diameter.

However, in this configuration, there is inevitably a moment when light is not incident on the pupil when the pupil of the user moves (that is, when the viewpoint moves), and the user periodically observes an invisible region such as a black frame. Accordingly, it is difficult to say that sufficiently favorable display for the user is provided in the technology described in the above-described Patent Literature 1.

On the other hand, in the first embodiment, as described above, the size ds of the sampling region 207 is preferably 0.6 (mm) or less and a plurality of sampling regions 207 are set on the pupil as illustrated in FIG. 17. Then, light incident on each sampling region 207 is controlled. Accordingly, even when the viewpoint moves, there is no phenomenon in which pictures are discontinuously displayed as in the technology described in the above-described Patent Literature 1 and it is possible to provide the user with more preferable display.

### (2-2-3-2. Iteration Cycle of Irradiation State of Sampling Region)

As described above, in the first embodiment, in order to cope with the movement of the user's viewpoint, a distance (DLP) between the lens surface 125 of the microlens array 120 and the pupil, a distance (DXL) between the pixel array 110 and the microlens array 120, a pitch of the microlenses 121 in the microlens array 120, a pixel size and a pitch of the pixel array 110, and the like are set so that the irradiation state of light on each sampling region 207 is periodically iterated in units larger than the maximum pupil diameter of the user. The conditions required for the iteration cycle of the irradiation state of the sampling region 207 will be specifically examined.

The iteration cycle of the irradiation state of the sampling region 207 (hereinafter also simply referred to as an iteration cycle) can be set on the basis of the user's pupil distance (PD). Assuming that a group of sampling regions 207 corresponding to one cycle of iteration cycles is called a sampling region group for convenience, an iteration cycle λ corresponds to a size (length) of the sampling region group.

Normal viewing is hindered at the moment when the viewpoint of the user transits between sampling region groups. Accordingly, in order to decrease a frequency of occurrence of disturbance of such display in accordance with the movement of the viewpoint of the user, the optimum design of the iteration cycle λ is important.

For example, if the iteration cycle λ is larger than the PD, the left and right eyes can be included within the same iteration cycle. Accordingly, for example, the naked eye 3D display technology is used, so that it is possible to perform stereoscopic viewing as well as display for compensating for the visual acuity described in the above (2-2-2-2. Visual acuity compensation mode). Also, although normal viewing is hindered at the moment when the viewpoint of the user transits between the sampling region groups, the frequency of disturbance of such display can be decreased because the frequency of transition of the user's viewpoint between sampling region groups is lowered even when the viewpoint is moved by increasing the iteration cycle λ. In this manner, when implementing functions other than visual acuity compensation such as stereoscopic vision, it is preferable that the iteration cycle λ be as large as possible.

However, in order to increase the iteration cycle λ, it is necessary to increase the number of pixels 111 of the pixel array 110. An increase in the number of pixels causes manufacturing costs and power consumption to be increased. Accordingly, there is inevitably a limit to increasing the iteration cycle λ.

From the viewpoints of manufacturing costs and power consumption, when the iteration cycle λ is set to be equal to or less than PD, it is desirable that the iteration cycle λ be set to satisfy the following Equation (3). Here, n is an arbitrary natural number.

[Math. 3]

λ×n=PD (3)

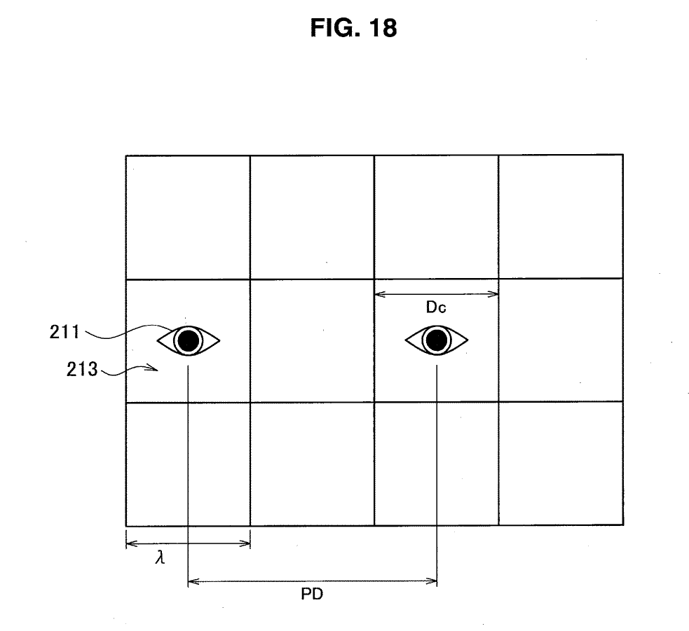

A relationship between λ and PD when the iteration cycle λ satisfies the above-described Equation (3) is illustrated in FIG. 18. FIG. 18 is a diagram illustrating the relationship between λ and PD when the iteration cycle λ satisfies Equation (3). Positional relationships between the sampling region group 213 including sampling regions 207 and the left and right eyes 211 of the user when the iteration cycle λ satisfies the above-described Equation (3) are illustrated in FIG. 18. In the example illustrated in FIG. 18, the sampling region group 213 is set as a substantially square region in a plane including the pupil of the user.

Here, as described above, normal viewing is hindered at the moment when the viewpoint of the user transits between the sampling region groups 213. However, when the iteration cycle λ satisfies the above-described Equation (3), for example, when the user's viewpoint moves in the left and right directions of the drawing sheet, the left and right eyes 211 pass through the boundary between the sampling region groups 213 at the same time. Accordingly, if a continuous region in which normal viewing is possible in both of the left and right eyes 211 is referred to as a continuous display region when the viewpoint moves, the continuous display region can be maximized when the iteration cycle λ satisfies the above-described Equation (3). In FIG. 18, a width Dc (continuous display width Dc) of the continuous display region in the left-right direction on the drawing sheet is indicated by a double-ended arrow. At this time, Dc=λ.

In contrast, when the iteration cycle λ is set to satisfy the following Equation (4), the continuous display region becomes the smallest.

[Math. 4]

λ×(n+0.5)=PD (4)

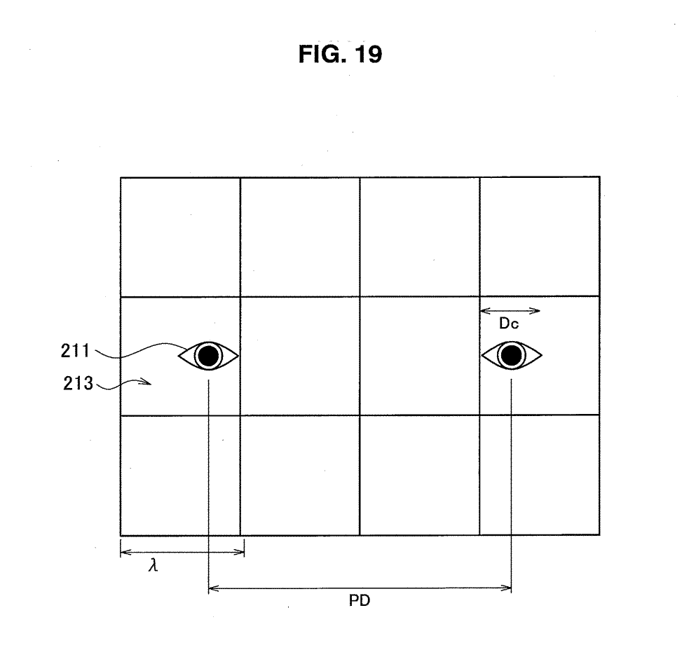

A relationship between λ and PD when the iteration cycle λ satisfies the above-described Equation (4) is illustrated in FIG. 19. FIG. 19 is a diagram illustrating the relationship between λ and PD when the iteration cycle λ satisfies Equation (4). Positional relationships between the sampling region group 213 including the sampling regions 207 and the left and right eyes 211 of the user when the iteration cycle λ satisfies Equation (4) are illustrated in FIG. 19.

In FIG. 19, as in FIG. 18, the width Dc (continuous display width Dc) in the left-right direction of the drawing sheet of the continuous display region is indicated by a double-end arrow. As illustrated in FIG. 19, when the iteration cycle λ satisfies the above-described Equation (4), if the left and right eyes 211 of the user only slightly move in the left-right direction of the drawing sheet, either one of the left and right eyes 211 will pass through the boundary between sampling region groups 213. Therefore, when the iteration cycle λ satisfies the above-described Equation (4), the continuous display region becomes smaller. At this time, Dc=λ/2.

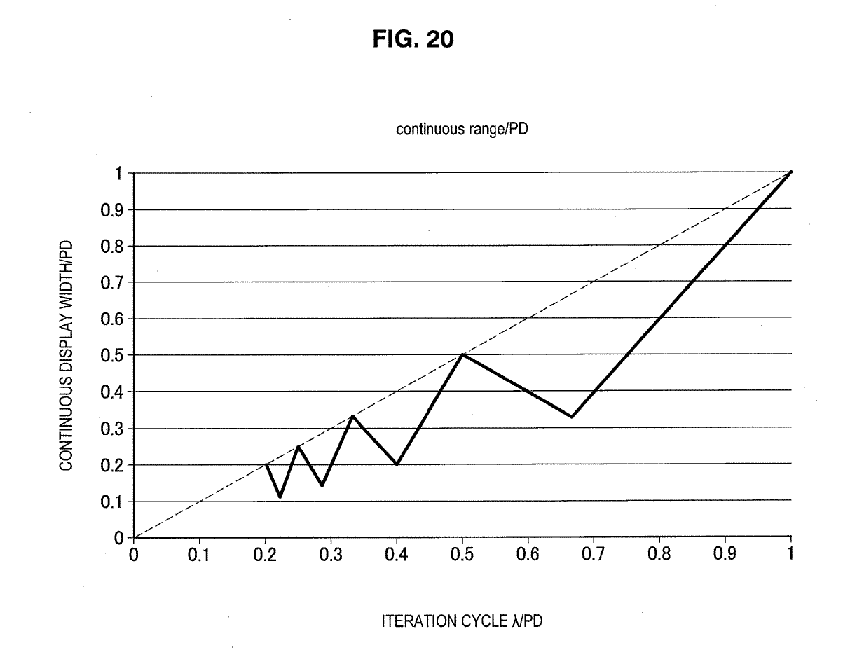

FIG. 20 is a diagram illustrating an influence of the relationship between the iteration cycle λ and the PD on the size of the continuous display region. In FIG. 20, a ratio between the iteration cycle λ and the PD (iteration cycle λ/PD) is taken on the horizontal axis, a ratio between the continuous display width Dc and PD (continuous display width Dc/PD) is taken on the vertical axis, and a relationship between the two ratios is plotted.

As illustrated in FIG. 20, when the iteration cycle λ satisfies the above-described Equation (3) (corresponding to the point where the value on the horizontal axis is 1, 1/2, 1/3, . . . ), the continuous display width Dc/PD has the same value as the iteration cycle λ/PD. That is, the continuous display width Dc takes λ which is a highest efficiency value.

On the other hand, when the iteration cycle λ satisfies the above-described Equation (4) (corresponding to the point where the value on the horizontal axis is 1/1.5, 1/2.5, 1/3.5, . . . ), the continuous display width Dc/PD takes a value of 1/2 of the iteration cycle λ/PD. That is, the continuous display width Dc takes λ/2 which is a lowest efficiency value.

The conditions required for the iteration cycle of the irradiation state of the sampling region 207 have been described above. As described above, it is also possible to apply the display device 10 to another field of application such as stereoscopic viewing by setting the iteration cycle λ of the irradiation state of the sampling region 207 to be larger than the PD. However, because it is necessary to increase the number of pixels 111 of the pixel array 110 in order to increase the iteration cycle λ, there is a limit in terms of manufacturing costs and power consumption. On the other hand, when an objective is to only compensate for the visual acuity, it is not always necessary to make the iteration cycle λ larger than PD. In this case, it is desirable that the iteration cycle λ be set to satisfy the above-described Equation (3). By setting the iteration cycle λ to satisfy the above-described Equation (3), the continuous display region can be maximized most efficiently and convenience for the user can be further improved.

### 2-3. Display Control Method

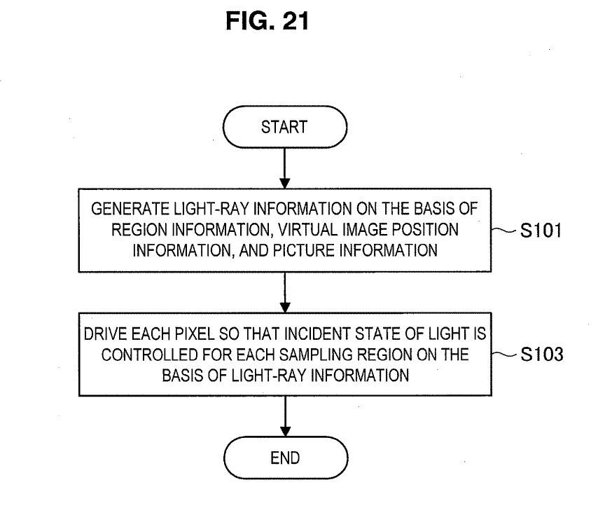

The display control method executed in the display device 10 according to the first embodiment will be described with reference to FIG. 21. FIG. 21 is a flowchart illustrating an example of a processing procedure of the display control method according to the first embodiment. Each process illustrated in FIG. 21 corresponds to that executed by the control unit 130 illustrated in FIG. 10.

Referring to FIG. 21, in the display control method according to the first embodiment, light-ray information is first generated on the basis of region information, virtual image position information, and picture information (step S101). The region information is information about a sampling region group including a plurality of sampling regions set on a plane including the user's pupil and substantially parallel to the display surface (the lens surface 125 of the microlens array 120) of the display device 10 illustrated in FIG. 10. Also, the virtual image position information is information about a position (virtual image generation position) at which a virtual image is generated in the display device 10 illustrated in FIG. 10. For example, the virtual image generation position is set to a position in focus for the user. Also, the picture information is two-dimensional picture information to be presented to the user.

In the process shown in step S101, information indicating the light-ray state is generated as light-ray information so that light from the picture based on the picture information displayed at the virtual image generation position based on the virtual image position information is incident on each sampling region included in the sampling region group. The light-ray information includes information about the emission state of light in each microlens 121 and information about the irradiation state of the light to each sampling region 207 for reproducing the light-ray state. Also, the process shown in step S101 corresponds to, for example, a process to be performed by the light-ray information generating unit 131 illustrated in FIG. 10.

Next, on the basis of the light-ray information, each pixel is driven so that the incident state of light is controlled for each sampling region (step S103). Thereby, the light-ray state as described above is reproduced, and a virtual image of a picture based on the picture information is displayed at the virtual image generation position based on the virtual image position information. That is, clear display in focus for the user is implemented.

The display control method according to the first embodiment has been described above.

### 2-4. Application Examples

Several application examples of the display device 10 according to the above-described first embodiment will be described.

### (2-4-1. Application to Wearable Device)

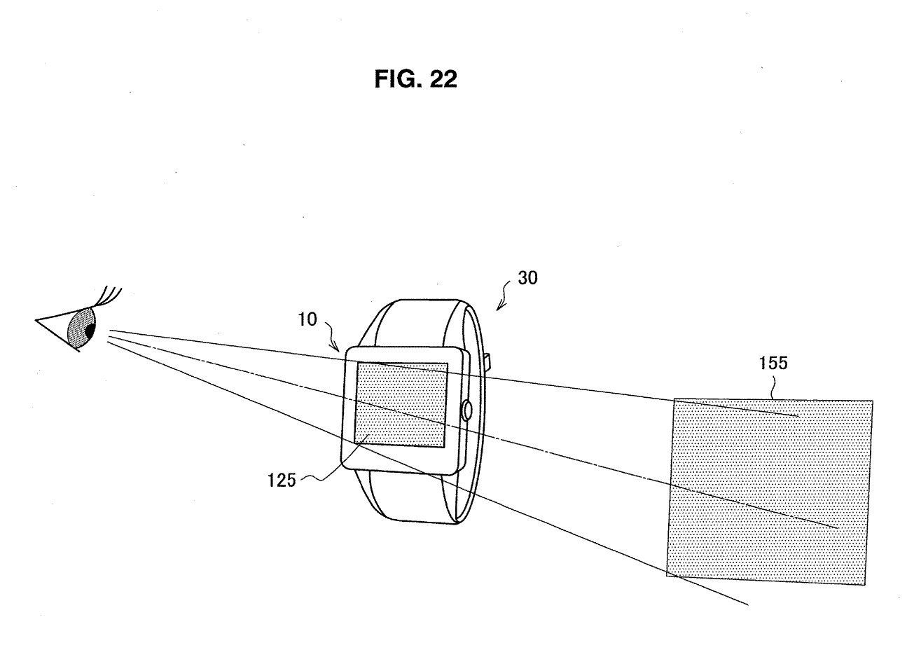

An example of a configuration in which the display device 10 according to the first embodiment is applied to a wearable device will be described with reference to FIG. 22. FIG. 22 is a diagram illustrating an example of a configuration in which the display device 10 according to the first embodiment is applied to a wearable device.

As illustrated in FIG. 22, the display device 10 according to the first embodiment can be preferably applied to a device having a relatively small display screen such as a wearable device 30. In the illustrated example, the wearable device 30 is a wristwatch type device.

In a mobile device such as the wearable device 30, the size of the display screen is limited to a relatively small size in consideration of portability for the user. However, as described in the above (1. Background of present disclosure), in recent years, the amount of information handled by users has increased and it is necessary to display more information on one screen. For example, there is a possibility that it will be difficult for a user with presbyopia to visually recognize the display on the screen due to simply increasing the amount of information displayed on the screen.

On the other hand, according to the first embodiment, as illustrated in FIG. 22, a virtual image 155 of a picture displayed on the display surface 125 can be generated at a position different from the real display surface 125. Accordingly, the user can observe fine display without wearing optical compensation instruments such as presbyopic glasses. Accordingly, even for a relatively small screen such as the wearable device 30, it is possible to perform high-density display and provide more information to the user.

### (2-4-2. Application to Other Mobile Device)

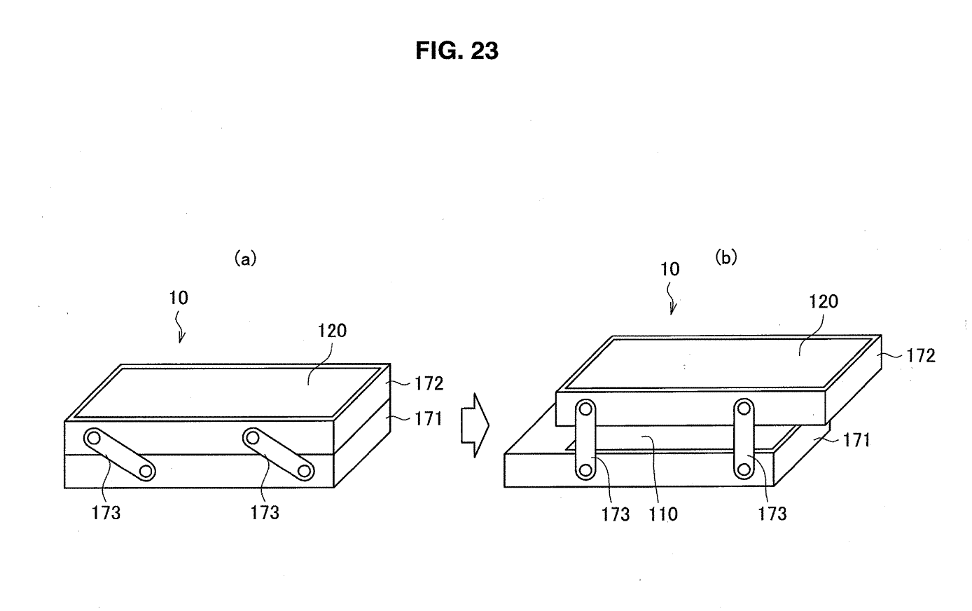

An example of a configuration in which the display device 10 according to the first embodiment is applied to another mobile device such as a smartphone will be described with reference to FIG. 23. FIG. 23 is a diagram illustrating an example of a configuration in which the display device 10 according to the first embodiment is applied to another mobile device.

In the example of the configuration illustrated in FIG. 23, when the display device 10 is mounted in a mobile device such as a smartphone, a first housing 171 on which the pixel array 110 is mounted and a second housing 172 on which the microlens array 120 is mounted are configured as different housings from each other and the first housing 171 and the second housing 172 are connected to each other by a connection member 173, so that the mobile device having the display device 10 is configured. The first housing 171 corresponds to the main body of the mobile device and a processing circuit for controlling the operation of the entire mobile device including the display device 10 and the like may be mounted within the first housing 171.

The connection member 173 is a bar-like member having rotary shaft portions provided at both ends thereof. As illustrated, one of the rotating shaft portions is connected to the side surface of the first housing 171 and the other of the rotating shaft portions is connected to the side surface of the second housing 172. In this manner, the first housing 171 and the second housing 172 are rotatably connected to each other by the connection member 173. Thereby, as illustrated, switching between a state in which the second housing 172 is in contact with the first housing 171 ((a) in FIG. 23) and a state in which the second housing 172 is located at a predetermined distance from the first housing 171 ((b) in FIG. 23) is performed.

Here, as described in the above (2-2-1. Device configuration), in the display device 10, the lens inter-pixel distance DXL is an important factor for determining the projection size of the light beam on the pupil, the iteration cycle of the irradiation state of light with respect to each sampling region 207, and the like. However, if the mobile device is configured so that the predetermined DXL is always secured when the display device 10 is mounted on the mobile device, the volume of the mobile device is increased and the increase in the volume is not preferable from the viewpoint of portability. Accordingly, when mounting the display device 10 on the mobile device, it is preferable that a movable mechanism that makes the DXL variable be provided in the microlens array 120 and the pixel array 110.

The configuration illustrated in FIG. 23 shows an example of a configuration in which such a movable mechanism is provided in the display device 10. In the mobile device illustrated in FIG. 23, when the display device 10 is not used, the mobile device is set to a state in which the second housing 172 is in contact with the first housing 171 as illustrated in (a) of FIG. 23. In this state, the microlens array 120 and the pixel array 110 are arranged so that the DXL becomes smaller and the mobile device can be kept at a smaller volume. On the other hand, in the mobile device illustrated in FIG. 23, the length of the connection member 173 is adjusted so that the DXL becomes a predetermined distance taking into consideration the projection size of the light beam on the pupil and/or the iteration cycle of the irradiation state of light in the state in which the second housing 172 illustrated in (b) of FIG. 23 is located at a predetermined distance from the first housing 171. Accordingly, by setting the second housing 172 to be separated from the first housing 171 as illustrated in (b) of FIG. 23 when the display device 10 is used, it is possible to arrange the microlens array 120 and the pixel array 110 so that the DXL has a predetermined distance taking into consideration various conditions described above and perform display in the visual acuity compensation mode.

In this manner, by providing a mechanism for making the DXL variable when the display device 10 is mounted on a mobile device, both of the decrease of the volume when it is not used (that is, when it is carried) and the visual acuity compensation effect when it is used can coexist and convenience for the user can be further improved.

Also, even when the DXL is minimized when it is not used, the display device 10 can perform display in the normal mode. Because the lens effect in the microlens array 120 is also minimized when the DXL is minimized, display can be performed in the same manner as ordinarily (that is, there is no visual acuity compensation effect) due to the pixel array 110. Also, in the configuration example illustrated in FIG. 23, a movable mechanism that makes the distance between the first housing 171 and the second housing 172 variable is provided, but an example of a configuration of the mobile device is not limited to this example. For example, instead of or in addition to the movable mechanism, a detachable mechanism capable of detaching the second housing 172 from the first housing 171 may be provided. With an attaching/detaching mechanism, the mobile device can be kept at a small volume when the display device 10 is not used by detaching the second housing 172 from the first housing 171, and the second housing 172 is attached at a predetermined distance from the first housing 171 when the display device 10 is used and therefore display in the visual acuity compensation mode can be performed.

### (2-4-3. Application to Electronic Loupe Device)

Generally, a visual acuity compensation device (hereinafter referred to as an “electronic loupe device”) in which a camera is provided on the surface of a housing and information on the paper surface photographed by the camera is enlarged and displayed on a display screen provided on the back surface of the housing is known. A user can read an enlarged map, characters, or the like via the display screen by placing the electronic loupe device on, for example, a surface of paper such as a map or a newspaper, so that the camera faces the paper surface. The display device 10 according to the first embodiment can also be preferably applied to such an electronic loupe device.

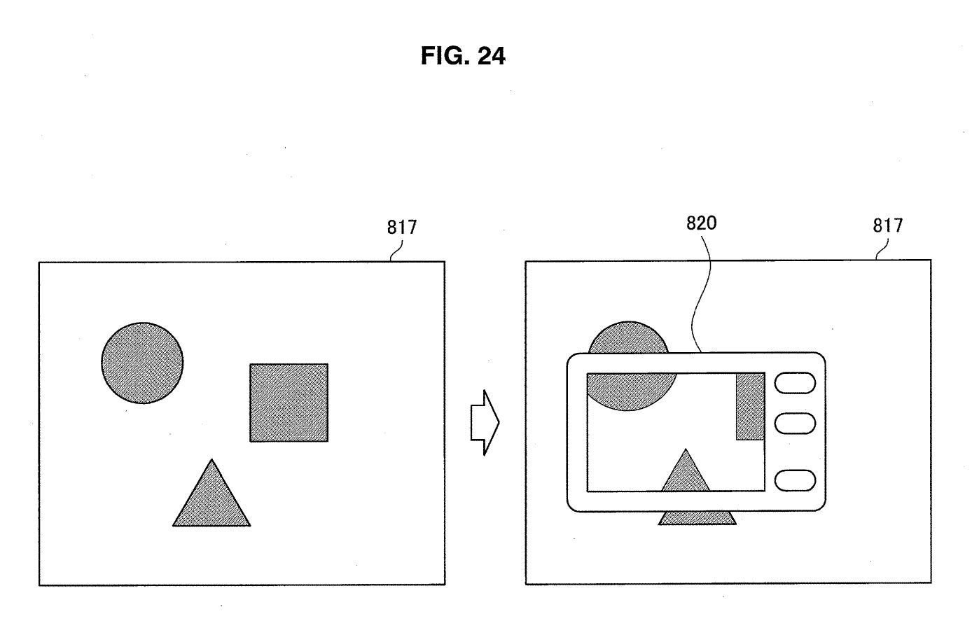

FIG. 24 illustrates an example of a general electronic loupe device. FIG. 24 is a diagram illustrating an example of a general electronic loupe device. As described above, the camera is mounted on the surface of the housing of the electronic loupe device 820. As illustrated, the electronic loupe device 820 is placed on a paper surface 817 so that the camera faces the paper surface 817. Graphics, characters, and the like on the paper surface 817 photographed by the camera are appropriately enlarged and displayed on the display screen of the back side of the housing of the electronic loupe device 820. Thereby, for example, a user who experiences difficulty in reading graphics and characters with small sizes due to presbyopia or the like can read the information on the paper surface more easily.

Here, the general electronic loupe device 820 as illustrated in FIG. 24 merely enlarges and displays a captured picture simply at a predetermined magnification, unlike a loupe made of optical lenses. Accordingly, because the user needs to enlarge the display to such an extent that it can be read without blur, the number of characters (an amount of information) to be displayed on the display screen at a time decreases. Consequently, when attempting to read a wide area of information within the paper surface 817, it is necessary to frequently move the electronic loupe device 820 on the paper surface 817.

On the other hand, when the display device 10 according to the first embodiment is mounted on the electronic loupe device, for example, a configuration example in which a camera is mounted on the front surface of the housing and the display device 10 is mounted on the back surface of the housing can be conceived. By placing the electronic loupe device so that the surface on which the camera is provided faces the paper surface and driving the electronic loupe device, a picture including information on the paper surface photographed by the camera can be displayed by the display device 10 mounted on the back surface of the housing.

If the display device 10 is driven in the visual acuity compensation mode, it is possible to perform display for remedying blur originally due to presbyopia or the like without enlarging the picture. As described above, in an electronic loupe device on which the display device 10 is mounted, unlike a general electronic loupe device 820, it is possible to perform visual acuity compensation without decreasing the amount of information to be displayed on the display screen at a time. Accordingly, even when a wide area of information within the paper surface is intended to be read, it is not necessary to frequently move the electronic loupe device on the paper surface and the user's readability can be significantly improved.

Several application examples of the display device 10 according to the first embodiment have been described above. However, the first embodiment is not limited to the above-described examples and the device to which the display device 10 is applied may be another device. For example, the display device 10 may be mounted on a mobile device in a form other than a wearable device or a smartphone. Alternatively, a device to which the display device 10 is applied is not limited to a mobile device and may be applied to any device as long as a device having a display function such as a stationary television is provided.

(2-4-4. Application to in-Vehicle Display Device)

In recent years, in automobiles, technology for displaying driving support information on a display device and presenting the driving support information to a driver has been developed. For example, there is technology for providing a display device on an instrument panel of a dashboard and displaying information about instruments such as a speedometer and a tachometer on the display device. Technology for providing a display device instead of a mirror at a position corresponding to a rearview mirror or a door mirror and displaying a video captured by the in-vehicle camera on the display device to replace the mirror is also known.

Here, the driver is considered to repeatedly view the outside world through the windshield and view instruments and mirrors present relatively close to the driver when focusing on the movement of the visual line of the driver during driving. That is, the visual line of the driver can reciprocate back and forth between a far position and a near position. At this time, focusing is performed in accordance with the movement of the visual line in the eyes of the driver, but the time taken for the focusing is problematic in terms of ensuring safety in a vehicle moving at a high speed. Even when instruments and mirrors are replaced with display devices as described above, a similar problem may occur.

On the other hand, by applying the display device 10 according to the first embodiment to the in-vehicle display device for displaying the driving support information as described above, the above-described problem can be solved.

Specifically, because the virtual image can be generated behind (at a position far from) the real display surface (that is, the microlens array 120), the display device 10 can display various kinds of information at a distance similar to that when the user views the outside world via the windshield when the user as the driver views the display device 10 by setting a virtual image generation position to a sufficiently far position. Accordingly, even when the user alternately views the state of the outside world and the driving support information in the in-vehicle display device 10, the time required for focusing can be shortened.

As described above, the display device 10 can be preferably applied to an on-vehicle display device that displays driving support information. By applying the display device 10 to the in-vehicle display device, there is a possibility of fundamentally solving the safety problem caused by the focusing time of the driver's field of view as described above.

### 2-5. Modified Example

Several modified examples of the first embodiment described above will be described.

(2-5-1. Decrease of Pixel Size in Accordance with Aperture)

As described in the above (2-2-1. Device configuration), in the display device 10, there are correlations between a projection size (corresponding to the sampling region 207) of light on the pupil from a pixel, image magnification, and a size (resolution) of a pixel 111 of the pixel array 110. Specifically, assuming that the size of the sampling region 207 is ds, the size of the pixel 111 is dp, and the image magnification is m, they have a relationship shown in the following Equation (5).

[Math. 5]

ds=dp×m (5)

Also, the image magnification m is represented as a ratio between a viewing distance (a distance between the lens surface 125 of the microlens array 120 and the pupil illustrated in FIG. 10) DLP and a lens inter-pixel distance (a distance between the lens surface 125 of the microlens array 120 and the display surface 115 of the pixel array 110 illustrated in FIG. 10) DXL by the following Equation (6).

[Math. 6]

m=DLP/DXL (6)

Here, a focal length f of the microlens 121 is assumed to satisfy the following Equation (7).

[Math. 7]

1/f=1/DLP+1/DXL (7)

As shown in the above-described Equations (5) and (6), the size dp of the pixel 111 is determined by the image magnification of the projection system of the microlens 121 that projects the pixel 111 onto the user's pupil. For example, according to requirements of another design matter, when the DXL needs to be decreased in a product or when the DLP needs to be increased, the image magnification m may need to be increased and the size dp of the pixel 111 may need to be decreased.

Here, if the size dp of the pixel 111 is simply decreased, the number of pixels 111 included in the pixel array 110 is increased and the increase in the number of pixels 111 may be undesirable in terms of manufacturing costs or power consumption. Therefore, as a method of decreasing the size dp of the pixel 111 while keeping the size ds of the sampling region at a small value and without increasing the number of pixels, a method of decreasing the size dp of the pixel 111 using a shielding plate having an aperture may be conceived. Also, in order to distinguish it from a shielding plate provided with an aperture used in the following (2-5-2. Example of configuration of light emission point other than microlens), the shielding plate used to decrease the size dp of the pixel 111 may be referred to as a first shielding plate in the present description.

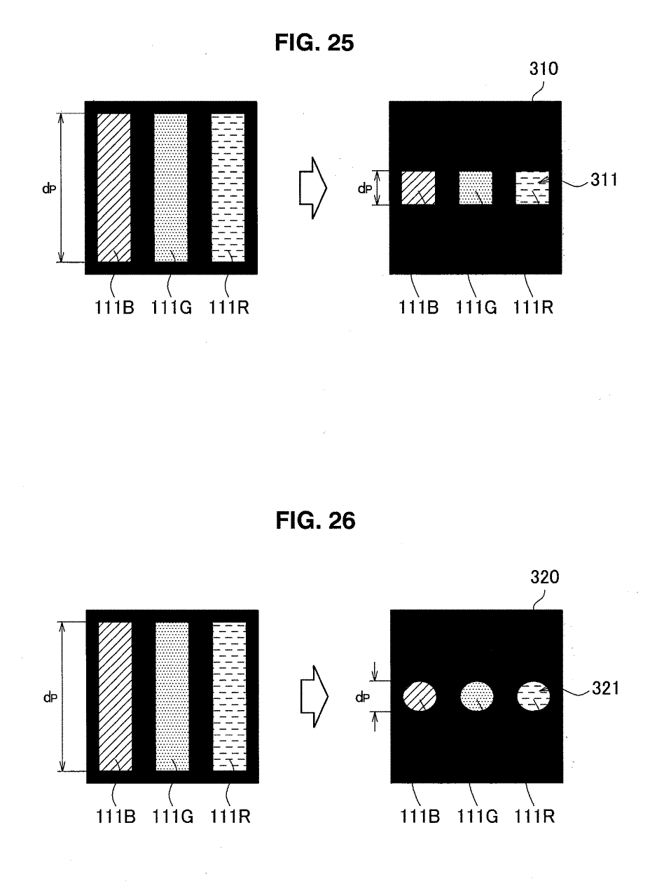

FIG. 25 is a schematic diagram illustrating a state of a decrease of a pixel size dp by a first shielding plate having a rectangular opening (aperture). Referring to FIG. 25, the shielding plate 310 is provided with a rectangular opening 311 at a position corresponding to each pixel 111 (111R, 111G, or 111B). A pixel 111R in FIG. 25 indicates a pixel that emits red light, a pixel 111G indicates a pixel that emits green light, and a pixel 111B indicates a pixel that emits blue light.

The size of the opening 311 is smaller than the sizes of the pixels 111R, 111G, and 111B. By providing the shielding plate 310 to cover the pixels 111R, 111G, and 111B, it is possible to apparently decrease the sizes dp of the pixels 111R, 111G, and 111B.

FIG. 26 is a diagram illustrating an example of another configuration of the first shielding plate and is a schematic diagram illustrating a state of a decrease of a pixel size dp by a first shielding plate having a circular opening (aperture). Referring to FIG. 26, the shielding plate 320 is provided with a circular opening 321 at a position corresponding to each pixel 111 (111R, 111G, or 111B). The size of the opening 321 is smaller than the sizes of the pixels 111R, 111G, and 111B. By providing the shielding plate 320 to cover the pixels 111R, 111G, and 111B, it is possible to apparently decrease the sizes dp of the pixels 111R, 111G, and 111B.

Here, in the examples illustrated in FIGS. 25 and 26, the shielding plates 310 and 320 are provided on the display surface of the pixel array 110. However, in this modified example, the position at which the first shielding plate is provided is not limited to the display surface. For example, when the pixel array 110 is provided as a transmissive pixel array such as a pixel array of a liquid crystal display device, the first shielding plate may be provided between the backlight and the liquid crystal layer (liquid crystal panel) in the liquid crystal display device.

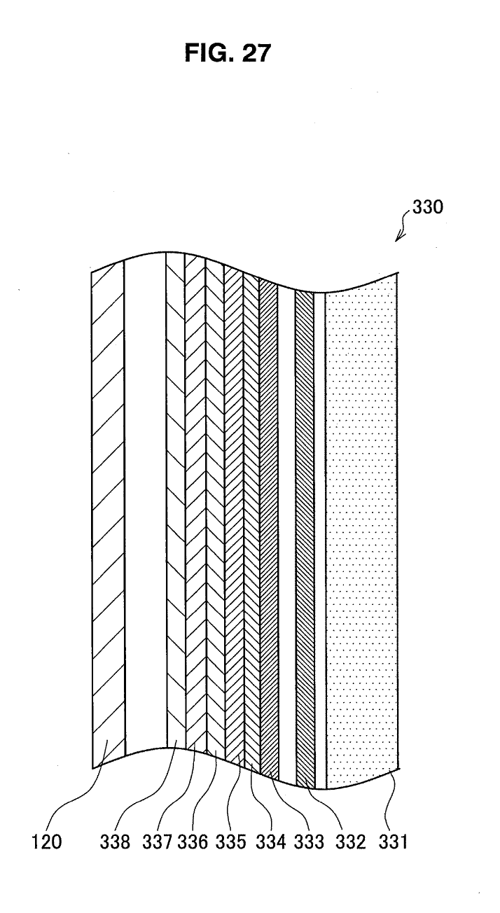

An example of a configuration in which such a first shielding plate is provided between the backlight and the liquid crystal layer is illustrated in FIG. 27. FIG. 27 is a diagram illustrating an example of a configuration in which the first shielding plate is provided between the backlight and the liquid crystal layer.

A cross-sectional view in a direction perpendicular to the display surface of a liquid crystal display device to which the first shielding plate is added is illustrated in FIG. 27. Referring to FIG. 27, the liquid crystal display device 330 includes a backlight 331, a diffusion plate 332, an aperture film 333, a polarization plate 334, a thin film transistor (TFT) substrate 335, a liquid crystal layer 336, a color filter substrate 337, and a polarization plate 338 stacked in this order. Because the configuration of the liquid crystal display device 330 is similar to that of a general liquid crystal display device except that the aperture film 333 is provided, a detailed description of the configuration will be omitted.

In this modified example, the pixel array of the liquid crystal display device 330 includes the pixel array 110 illustrated in FIG. 10. In FIG. 27, the microlens array 120 is also illustrated to correspond with FIG. 10.

The aperture film 333 corresponds to the above-described first shielding plates 310 and 320. The aperture film 333 has a configuration in which a plurality of optical openings (apertures (not illustrated)) are provided in correspondence with the positions of the pixels in the light shielding member and the light from the backlight 331 passes through the opening portion and is incident on the liquid crystal layer 336. Accordingly, because the aperture film 333 shields light outside a position at which the opening is provided, the pixel size is substantially decreased.

Here, a reflection layer that reflects light may be provided on the surface on the backlight side of the aperture film 333. When the reflection layer is provided, light from the backlight 331 that is not transmitted through the opening from light from the backlight 331 is reflected by the reflection layer toward the backlight 331. Reflected and returned light is reflected inside the backlight 331 again and emitted toward the aperture film 333 again. If there is no optical absorption in the reflecting surface of the aperture film 333 and the backlight 331, all the light is ideally reflected and incident on the liquid crystal layer 336 and loss of light is eliminated. Alternatively, a similar effect can be obtained also when the aperture film 333 itself of a material having high reflectance is formed instead of providing the reflection layer. In this manner, by providing a reflection layer on the surface of the aperture film 333 on the backlight side or by forming the aperture film 333 itself of a material with high reflectance, loss of light can be minimized even when the size of the opening is small, because light is recycled between the backlight 331 and the aperture film 333, so to speak.

Also, as another configuration, it is also possible to implement a configuration in which a positional relationship between the aperture film 333 and the liquid crystal layer 336 is reversed in the configuration example described above. In this case, it is possible to use a self-luminous type display device which is not a transmissive type instead of the liquid crystal layer 336.

A modified example in which the pixel size is decreased using the first shielding plate has been described above.

(2-5-2. Example of Configuration of Light Emission Point Other than Microlens)

In the above-described embodiment, the display device 10 is configured by arranging the microlens array 120 on the display surface of the pixel array 110. In the display device 10, each microlens 121 may function as a light emission point. Here, the first embodiment is not limited to such an example, and the light emission point may be implemented by a configuration other than a microlens.

For example, instead of the microlens array 120 illustrated in FIG. 10, a shielding plate having a plurality of openings (apertures) can be used. In this case, each opening of the shielding plate functions as a light emission point. Also, to distinguish it from the shielding plate used in the above (2-5-1. Decrease of pixel size in accordance with aperture), a shielding plate used for configuring a light emission point instead of the microlens array 120 may be referred to as a second shielding plate in the present description.

The second shielding plate may have a configuration substantially similar to a parallax barrier used for a general 3D display device. In this modified example, a shielding plate having an opening at a position corresponding to the center of each microlens 121 illustrated in FIG. 10 is arranged on the display surface 115 of the pixel array 110 instead of the microlens array 120.

From optical considerations similar to the above-described Equations (5) and (6), the projection size of light (which corresponds to the sampling region) becomes ((pixel size of pixel array 110)+(diameter of aperture))×(distance between shielding plate and pupil)/(distance between pixel array 110 and shielding plate) when light from the pixel 111 passes through the opening of the shielding plate and is projected onto the pupil of the user. Accordingly, in consideration of the size of the sampling region of 0.6 (mm) or less, the opening of the shielding plate can be designed to satisfy the above-described conditions.

Here, when a shielding plate is used instead of the microlens array 120, light not passing through the opening is not emitted toward the user, resulting in a loss. Accordingly, compared with when the microlens array 120 is provided, the display observed by the user may become dark. Accordingly, when a shielding plate is used instead of the microlens array 120, it is preferable that each pixel be driven in consideration of such loss of light.

Also, when the pixel array 110 is configured using a transmissive display device such as a liquid crystal display device, a configuration in which the positional relationship between the second shielding plate and the transmissive pixel array 110 is reversed can also be similarly implemented. In this case, for example, the second shielding plate is arranged between the backlight and the liquid crystal layer. In this case, as in the configuration described above with reference to FIG. 27, it is possible to obtain the effect of decreasing light loss by providing a reflection layer on the backlight side surface of the second shielding plate or forming the second shielding plate itself with a material having high reflectance.

A modified example in which the light emission point is implemented by a configuration other than a microlens has been described above.

(2-5-3. Dynamic Control of Irradiation State in Accordance with Pupil Position Detection)

As described in the above (2-2-1. Device configuration), the display device 10 according to the first embodiment sets a sampling region group including a plurality of sampling regions on a plane including the user's pupil and controls the irradiation state of light for each sampling region. Also, as described in the above (2-2-3-2. Iteration cycle of irradiation state of sampling region), the irradiation state of light for each sampling region is iterated in a predetermined cycle. Here, when the user's eyes pass through a boundary between the sampling region groups corresponding to one cycle of iteration, the user does not recognize normal display.

As one method of avoiding such abnormal display when the viewpoint passes through the boundary between the sampling region groups, it is conceivable to increase the iteration cycle λ of the irradiation state of the sampling region. However, as described in the above (2-2-3-2: Iteration cycle of irradiation state of sampling region), when the iteration cycle λ is increased, the number of pixels in the pixel array is increased, the pixel pitch is decreased, power consumption is increased, and the like, thereby causing problems in terms of product specifications.

Therefore, as another method of avoiding abnormal display when the viewpoint passes through the boundary between the sampling region groups, a method of detecting a position of the user's pupil and dynamically controlling the irradiation state of the sampling region in accordance with the detected position may be conceived.

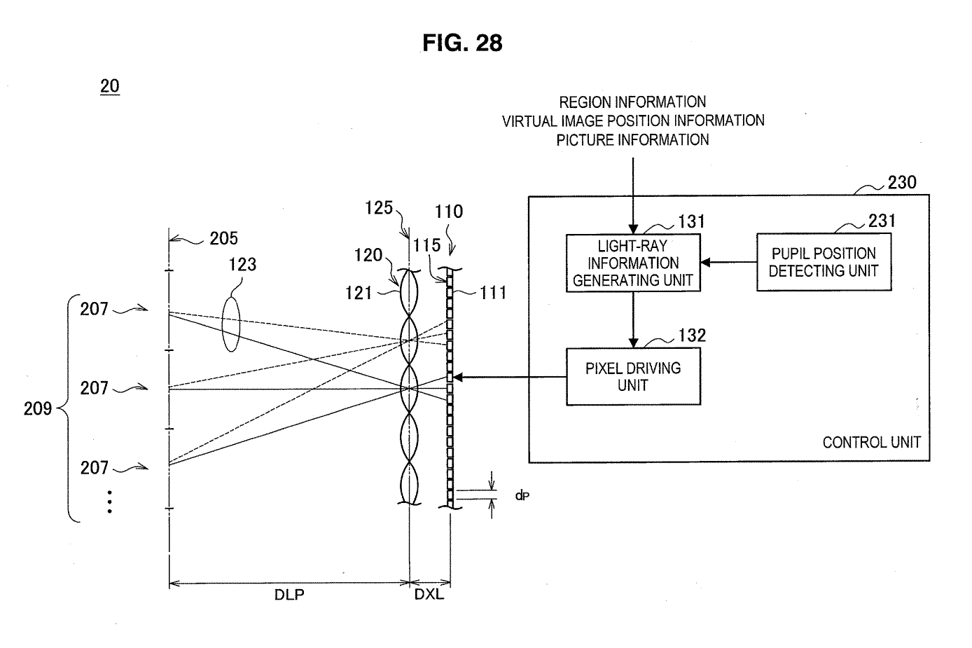

A configuration of a display device for implementing such dynamic control of the irradiation state in accordance with pupil position detection will be described with reference to FIG. 28. FIG. 28 is a diagram illustrating an example of a configuration of a display device according to a modified example in which dynamic control of the irradiation state in accordance with the pupil position detection is performed.

Referring to FIG. 28, the display device 20 according to the present modified example includes a pixel array 110 in which a plurality of pixels 111 are two-dimensionally arranged, a microlens array 120 provided on a display surface 115 of the pixel array 110, and a control unit 230 that controls driving of each pixel 111 of the pixel array 110. Each pixel 111 is driven by the control unit 230 on the basis of the light-ray information, so that, for example, the light-ray state of light from a picture on a virtual image surface located at a predetermined position is reproduced. Here, because the configurations and functions of the pixel array 110 and the microlens array 120 are similar to the configurations and functions of these members in the display device 10 illustrated in FIG. 10, a detailed description thereof will be omitted here.

The control unit 230 includes, for example, a processor such as a CPU or a DSP, and operates in accordance with a predetermined program, thereby controlling the driving of each pixel 111 of the pixel array 110. The control unit 230 has a light-ray information generating unit 131, a pixel driving unit 132, and a pupil position detecting unit 231 as functions thereof. Because the functions of the light-ray information generating unit 131 and the pixel driving unit 132 are substantially similar to the functions of these configurations in the display device 10 illustrated in FIG. 10, description of matters repeated from the control unit 130 of the display device 10 will be omitted and differences from the control unit 130 will mainly be described here.

On the basis of the region information, the virtual image position information and the picture information, the light-ray information generating unit 131 generates information indicating the light-ray state when light from a picture displayed on the virtual image surface is incident on each sampling region 207 as light-ray information. For example, the information about the cycle (iteration cycle λ) of iteratively reproducing the irradiation state of light for each sampling region 207 may be included in the region information. When the light-ray information is generated, the light-ray information generating unit 131 generates information about the irradiation state of light for each sampling region 207 in consideration of the iteration cycle λ.

The pixel driving unit 132 drives each pixel 111 of the pixel array 110 so that the incident state of light is controlled for each sampling region 207 on the basis of the light-ray information. Thereby, the above-described light-ray state is reproduced and a virtual image is displayed to the user.

The pupil position detecting unit 231 detects the position of the user's pupil. As a method in which the pupil position detecting unit 231 detects the position of the pupil, for example, any known method used in general visual line detection technology may be applied. For example, an imaging device (not illustrated) capable of photographing at least the face of the user may be provided in the display device 20, and the pupil position detecting unit 231 analyzes a captured picture acquired by the imaging device using a well-known picture analysis method, thereby detecting the position of the user's pupil. The pupil position detecting unit 231 provides information about the detected pupil position of the user to the light-ray information generating unit 131.

In the present modified example, the light-ray information generating unit 131 generates information about the irradiation state of light for each sampling region 207 so that that the pupil of the user is not positioned at a boundary between the sampling region groups, which are units of iterations of the irradiation state for each sampling region 207, on the basis of information about the position of the pupil of the user. The light-ray information generating unit 131 generates information about the irradiation state of light for each sampling region 207, for example, so that the user's pupil is always located at substantially the center of a sampling region group.

Each pixel 111 is driven by the pixel driving unit 132 on the basis of the above-described light-ray information, so that the position of the sampling region group in the sampling region groups 209 may be changed at any time in accordance with the movement of the position of the user's pupil in the present modified example so that the pupil is not positioned at a boundary between the sampling region groups. Accordingly, it is possible to prevent the viewpoint of the user from passing through a boundary between sampling region groups and it is possible to avoid the occurrence of abnormal display when the user's viewpoint passes through a boundary. Consequently, it is possible to decrease the stress of the user using the display device 20. Also, according to the present modified example, as in the case in which the iteration cycle λ is increased, the manufacturing costs and the power consumption are not increased, so that more comfortable display and optimization of costs, etc. can be compatible.

A modified example in which dynamic control of the irradiation state is performed in accordance with pupil position detection has been described above.

(2-5-4. Modified Example in which Pixel Array is Implemented by Printing Material)

Although the pixel array 110 is implemented as a configuration of a display device such as, for example, a liquid crystal display device, in the display device 10 described in the above (2-2-1. Device configuration), the first embodiment is not limited to such an example. For example, the pixel array 110 may be implemented by a printing material.

When the pixel array 110 is implemented by a printing material in the display device 10 illustrated in FIG. 10, a printing control unit can be provided instead of the pixel driving unit 132 as a function of the control unit 130. The printing control unit has a function of obtaining information to be displayed on the printing material through calculation on the basis of the light-ray information generated by the light-ray information generating unit 131 and controlling the operation of a printing unit including a printing device such as a printer so that information similar to that when the information is displayed on the pixel array 110 is printed on the printing material. The printing unit may be incorporated in the display device 10 or may be provided as a separate device different from the display device 10.

By arranging the printing material printed under the control of the printing control unit at the position of the pixel array 110 illustrated in FIG. 10 instead of the pixel array 110 and by using appropriate illumination as necessary, it is possible to display a virtual image at a predetermined position to the user and perform display for compensating for the visual acuity of the user as in the display device 10.

### 3. Second Embodiment

As described in the above (2-2-1. Device configuration), the display device 10 according to the first embodiment provides display corresponding to a virtual image to a user by reproducing a light-ray state from the virtual image when the virtual image is located at a predetermined position on the basis of virtual image position information. At this time, in the first embodiment, the position at which the virtual image is generated (the virtual image generation position) is appropriately set in accordance with the visual acuity of the user. For example, by setting the virtual image generation position at a focal position corresponding to the visual acuity of the user, it is possible to display a picture so as to compensate for the visual acuity of the user. However, as described below, when visual acuity compensation is performed by light-ray reproduction as in the first embodiment, there are predetermined restrictions when the display device 10 is configured and a degree of freedom of design is low. Here, as the second embodiment, an embodiment in which the user's visual acuity is compensated for by a different technique with a device configuration substantially similar to that of the display device 10 illustrated in FIG. 10 will be described.

### 3-1. Background of Second Embodiment

Prior to describing the configuration of the display device according to the second embodiment in detail, the background of the second embodiment that the present inventors have reached will be described to make the effects of the second embodiment clearer.

First, the results of examination of the display device 10 according to the first embodiment by the present inventors will be described. To effectively perform the visual acuity compensation in the display device 10 according to the first embodiment, the constituent members thereof needs to satisfy predetermined conditions. Specifically, in the display device 10, the specific configurations and arrangement positions of a pixel array 110 and a microlens array 120 can be determined in accordance with the performance required for a size ds for a sampling region 207, a resolution, an iteration cycle λ, etc.

For example, as described in the above (2-2-3-1. Sampling region), it is preferable that the size ds of the sampling region 207 be set to be sufficiently small with respect to a pupil diameter of the user, specifically, 0.6 (mm) or less, to provide the user with a favorable image that is not blurred. Here, there is a relationship expressed by the following Equation (8) between the size ds of the sampling region 207, a size dp of a pixel 111 of the pixel array 110, a viewing distance (a distance between a lens surface 125 of the microlens array 120 and the pupil) DLP, and a lens inter-pixel distance (a distance between the lens surface 125 of the microlens array 120 and a display surface 115 of the pixel array 110) DXL as shown in the above-described Equations (5) and (6).

$$\begin{matrix}[ Math . 8 ] & \\ ds = dp \times \frac{DLP}{DXL} & ( 8 )\end{matrix}$$

Accordingly, the size dp of the pixel 111, the viewing distance DLP, and the lens inter-pixel distance DXL can be determined in accordance with the size ds of the sampling region 207 required for the display device 10 (hereinafter referred to as condition 1). As described above, because it is preferable that the size ds of the sampling region 207 be small, for example, the size dp of the pixel 111, the viewing distance DLP, and the lens inter-pixel distance DXL are determined so that the size ds of the sampling region 207 is small.

Also, in the display device 10, each microlens 121 of the microlens array 120 behaves as a pixel. Accordingly, the resolution of the display device 10 is determined by the pitch of the microlenses 121. In other words, the pitch of the microlenses 121 can be determined in accordance with the resolution required for the display device 10 (hereinafter referred to as condition 2). Because it is generally preferable that the resolution be large, for example, the pitch of the microlenses 121 is required to be small.

Further, in terms of the resolution, the relationship of (resolution) ∝(viewing distance DLP+virtual image depth DIL)×lens inter-pixel distance DXL/(size dp of pixel 111×virtual image depth DIL) is established. Here, the virtual image depth DIL is a distance from the microlens array 120 to the virtual image generation position. Accordingly, the size dp of the pixel 111 and the lens inter-pixel distance DXL can also be determined in accordance with the resolution required for the display device 10 and the virtual image depth DIL (hereinafter referred to as condition 3).

As described in the above (2-2-1. Device configuration), the iteration cycle λ has a relationship of λ=(pitch of microlens 121)×(DLP+DXL)/DXL. Accordingly, the pitch of the microlenses 121, the viewing distance DLP, and the lens inter-pixel distance DXL can be determined in accordance with the iteration cycle λ required for the display device 10 (hereinafter referred to as condition 4). As described in the above (2-2-3-2. Iteration cycle of irradiation state of sampling region), it is preferable that the iteration cycle λ be large to more stably provide normal viewing to the user. Accordingly, for example, the pitch of the microlenses 121, the viewing distance DLP, and the lens inter-pixel distance DXL are determined so that the iteration cycle λ becomes large.

As described above, in the display device 10, various values related to the configurations and the arrangement positions of the pixel array 110 and the microlens array 120 such as the size dp of the pixel 111, the virtual image depth DIL, the pitch of the microlenses 121, the viewing distance DLP, and the lens inter-pixel distance DXL can be appropriately determined to satisfy conditions 1 to 4 required for the display device 10.

Here, when conditions 1 to 4 are considered to be simultaneously satisfied, the size dp of the pixel 111, the virtual image depth DIL, the pitch of the microlenses 121, the viewing distance DLP, the lens inter-pixel distance DXL, and the like cannot be independently set. For example, from the viewpoint of product performance, the resolution and iteration cycle λ required for the display device 10 are assumed to be determined. In this case, the pitch of the microlenses 121 can be determined to satisfy the resolution required for the display device 10 on the basis of condition 2. If the pitch of the microlenses 121 is determined, the lens inter-pixel distance DXL can be determined to satisfy the iteration cycle λ required for the display device 10 on the basis of condition 4.

For example, because the viewing distance DLP can be set as, for example, a distance at which the user generally observes the display device 10, the degree of freedom in designing the viewing distance DLP is small. Accordingly, if the pitch of the microlenses 121 and the lens inter-pixel distance DXL are determined, the size dp of the pixel 111 is determined to satisfy the size ds of the sampling region 207 required for the display device 10 on the basis of condition 1. Consequently, if the size ds of the sampling region 207 is intended to be decreased, the size dp of the pixel 111 also becomes relatively small in accordance therewith. As an example, when the resolution and the iteration cycle λ usable for practical use are secured and the size ds of the sampling region 207 is intended to be 0.6 (mm) or less, it is necessary to set the size dp of the pixel 111 to at least about several tens (μm) or less.

As described in the above (2-2-3-2: Iteration cycle of irradiation state of sampling region), if the size dp of the pixel 111 is further decreased and the number of pixels 111 is increased, manufacturing costs and power consumption may be increased. Also, as a pixel to be used for a display surface of a general mobile device such as a smartphone, a pixel having a size larger than several tens (μm) is widely used. Accordingly, because it is difficult to appropriate such a generally widely used pixel array for the pixel array 110 of the display device 10, it is necessary to separately manufacture a dedicated pixel array and hence the manufacturing costs may be increased.

Therefore, the present inventors investigated whether it is possible to implement technology for executing visual acuity compensation while maintaining the size dp of the pixel 111 at a predetermined size in a device configuration substantially similar to that of the display device 10.

The present inventors focused on the effect of optical resolution by the lens. In the above-described embodiment, by appropriately driving each pixel 111 of the pixel array 110 and controlling the light-ray state, a virtual image of the picture on the display surface of the pixel array 110 is generated at an arbitrary position. On the other hand, in general, a convex lens has a function of generating a virtual image of the physical object enlarged at a predetermined magnification at a predetermined position in accordance with a distance between the convex lens and the physical object and its focal length f. If the user observes the virtual image optically generated by such a convex lens, visual acuity compensation for, for example, a user having presbyopia, is considered to be able to be implemented.

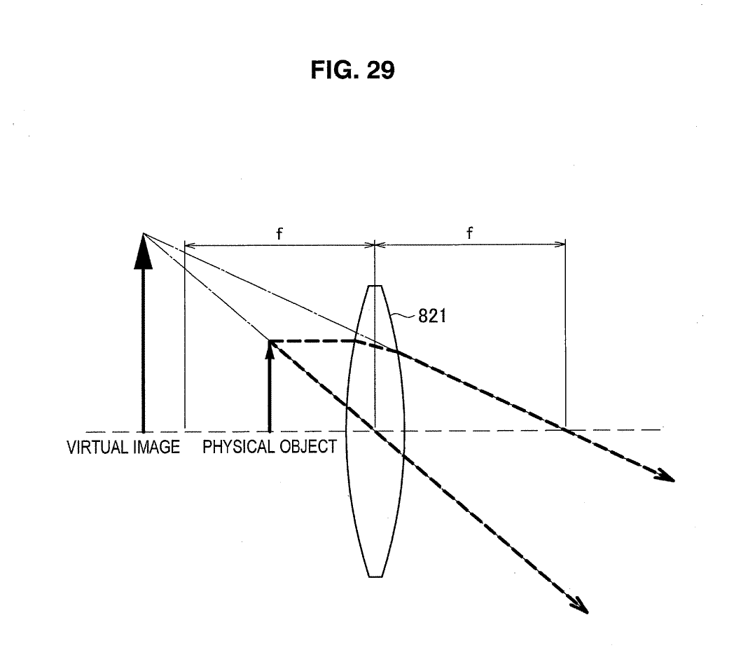

FIG. 29 is an explanatory diagram illustrating generation of a virtual image in a general convex lens. As illustrated in FIG. 29, in general, the convex lens 821 has a function of generating a virtual image in which the physical object is enlarged at a predetermined magnification behind the convex lens 821 (on an opposite side of the convex lens 821 when viewed from the user observing the physical object through the convex lens 821) when the physical object is located at a distance closer than the focal distance f. If the pixel array 110 is arranged at the position of the physical object, the user observes the virtual image of the picture on the display surface of the enlarged pixel array 110 through the convex lens 821. That is, this corresponds to an arrangement of a general magnifying glass (loupe) on the display surface of the pixel array 110.

There is a possibility that the amount of information to be displayed on one screen may be decreased by enlarging and displaying the physical object, but it is possible to cope with the decrease in the amount of information by decreasing display in the pixel array 110 in advance in view of the magnification of the convex lens 821. That is, it is only necessary to adjust the size of the picture to be displayed on the pixel array 110 so that the picture has an appropriate size when the picture is enlarged and observed as a virtual image by the user. Thereby, it is possible to cause the user to observe a resolved picture without decreasing the amount of information provided to the user.

Here, a process of performing the resolution as described above with one convex lens as in a general magnifying glass may be considered. For example, for a device configuration which can be normally assumed, when the size of the pixel array 110 is about a diagonal line length of 100 (mm) and a virtual image is generated at a depth of 400 (mm) from the lens, the distance between the pixel array 110 and the convex lens is about 20 (mm). In this case, the convex lens is required to have an angle of view of about 100 (mm) and a focal length of about 21 (mm), that is, the F value is required to be about 0.21, but a convex lens having such optical characteristics is not realistic. In other words, it is considered that it is difficult to implement the above-described visual acuity compensation by optical resolution using one convex lens.

Here, when attention is paid to one microlens 121 of the microlens array 120 in the configuration of the display device 10 illustrated in FIG. 10, each microlens 121 can have a function as a magnifying glass similar to the above-described convex lens 821. That is, each microlens 121 allows a user observing a physical object through the microlenses 121 to observe a virtual image in which the physical object is enlarged.

Accordingly, in the configuration of the display device 10 illustrated in FIG. 10, the microlens array 120 is arranged so that a virtual image of the display of the pixel array 110 can be generated by each microlens 121 of the microlens array 120 (that is, so that a distance from the pixel array 110 to the microlens 121 is less than the focal length of the microlens 121), thereby providing an enlarged and resolved picture (that is, a virtual image) to the user even when light-ray reproduction is not performed. At this time, if the size of the picture to be displayed on the pixel array 110 is adjusted in consideration of the magnification of each microlens 121 as described above, the amount of information to be provided to the user does not decrease.

In this manner, the display device 10 illustrated in FIG. 10 can be regarded as a display device in which a plurality of lenses (that is, microlenses 121) are arranged on the display surface side of the pixel array 110. Because each microlens 121 does not need to have a large angle of view so as to cover the entire display surface of the pixel array 110, the microlens 121 can be formed as a convex lens of a practical size.

However, even when the user observes a virtual image optically generated by each microlens 121 of the microlens array 120 in a state in which a picture is simply displayed on the display surface of the pixel array 110, the user cannot view the picture normally. It is only necessary to control the display in the pixel array 110 using a method similar to a general light-ray reproduction technology so that the picture can be observed as an integral picture continuously when the display surface of the pixel array 110 is observed from the predetermined position through the microlens array 120 so as to allow the user to observe a normal picture. That is, each pixel 111 of the pixel array 110 is driven so that light rays are emitted from the microlenses 121 to the user's pupil so that pictures to be visually recognized by the user through the microlenses 121 of the microlens array 120 are provided as a continuous and integral display.

Specifically, in the picture processing, it is only necessary to control light emitted from each microlens 121 so that the user can observe a virtual image of a continuous and integral picture. At that time, the position of the virtual image in the picture processing is adjusted to be equivalent to the virtual image generation position determined from the hardware configuration of the microlens 121. Thereby, the picture resolved by the microlens 121 is provided as a continuous picture to the user.

A result obtained by the present inventors examining whether it is possible to implement technology for executing visual acuity compensation while keeping the size dp of the pixel 111 at a predetermined size in a device configuration similar to that of the display device 10 illustrated in FIG. 10 has been described above. As described above, in the device configuration similar to that of the display device 10 illustrated in FIG. 10, it is possible to compensate for the visual acuity of the user according to a technique different from that of the above-described first embodiment by optically generating a virtual image of a picture on the display surface of the pixel array 110 by each microlens 121 of the microlens array 120, generating a virtual image using a method similar to light-ray reproduction so that the picture can be observed as a continuous and integral picture when the display surface of the pixel array 110 is observed through the microlens array 120 from a predetermined position, and making virtual image generation positions of the two virtual images equivalent.

According to this technique, because a virtual image is optically generated by the microlens 121, it is not necessary to set the sampling region 207 to a small region for visual acuity compensation. Consequently, it is unnecessary to consider the above-described condition 1. Also, because the resolution of the display device 10 can be determined in accordance with the magnification in the microlens 121 instead of the pitch of the microlenses 121, it is also unnecessary to consider the above-described condition 2.

Accordingly, according to this technique, it is possible to perform visual acuity compensation without decreasing the size dp of the pixel 111, in contrast to the first embodiment. Consequently, for example, a display (pixel array) which is generally widely used can be used as the pixel array 110 as it is and it is possible to configure a display device without increasing the manufacturing costs.

However, in this technique, the virtual image generation position can be determined in hardware in accordance with a distance between the microlens 121 and the display surface of the pixel array 110 (that is, the lens inter-pixel distance DXL) and the focal length f of the microlens 121. Accordingly, while there is an advantage in that it is unnecessary to decrease the size dp of the pixel 111 in the second embodiment, there is a disadvantage in that convenience for the user is decreased as compared with the first embodiment in which the virtual image generation position can be arbitrarily changed. Whether the technique of the first embodiment or the technique of the second embodiment is used may be appropriately determined in accordance with a situation and/a field of application.

### 3-2. Device Configuration

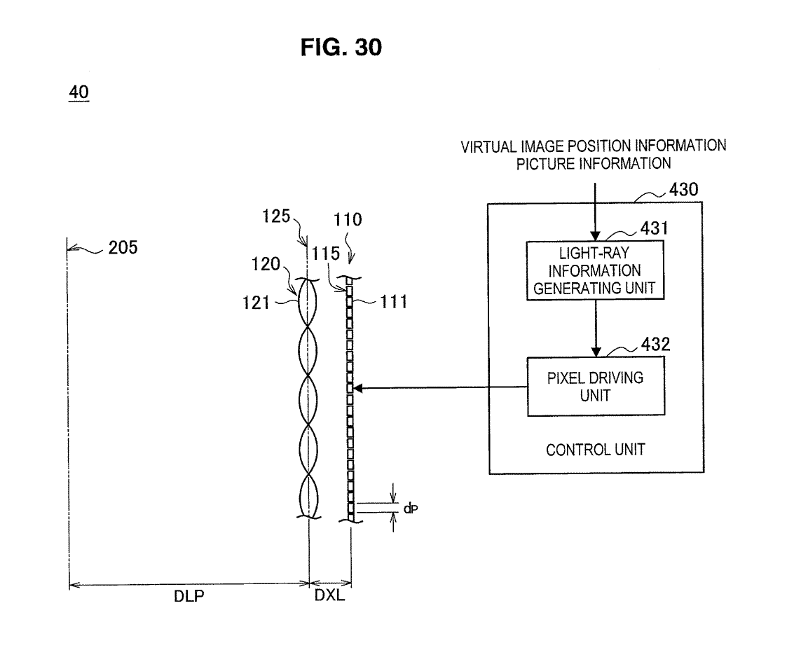

The configuration of the display device according to the second embodiment will be described with reference to FIG. 30. FIG. 30 is a diagram illustrating an example of the configuration of the display device according to the second embodiment.

Referring to FIG. 30, the display device 40 according to the second embodiment includes a pixel array 110 in which a plurality of pixels 111 are two-dimensionally arranged, a microlens array 120 provided on the display surface 115 of the pixel array 110 and a control unit 430 that controls the driving of each pixel 111 of the pixel array 110. Because the configurations of the pixel array 110 and the microlens array 120 are similar to the configurations of these members in the display device 10 illustrated in FIG. 10, detailed description thereof will be omitted here.

However, in the first embodiment, the distance between the pixel array 110 and the microlens array 120 is set to be longer than the focal length of each microlens 121 of the microlens array 120 to handle a real image. On the other hand, the pixel array 110 and the microlens array 120 are arranged so that the distance between the pixel array 110 and the microlens array 120 is smaller than the focal length of each microlens 121 of the microlens array 120 to optically generate a virtual image by each microlens 121 in the second embodiment.

Also, as described above, in the first embodiment, the pixel array 110 and the microlens array 120 need to be designed to satisfy all of the above-described conditions 1 to 4. Accordingly, the size dp of the pixel 111 and/or the pitch of the microlenses 121 tend(s) to be relatively small. On the other hand, in the second embodiment, conditions 1 and 2 among conditions 1 to 4 need not be considered. Accordingly, the size dp of the pixel 111 may be larger than that of the first embodiment and may be equivalent to, for example, that in a widely used general-purpose display.

However, also in the second embodiment, the pixel array 110 and the microlens array 120 are designed to satisfy conditions 3 and 4. That is, in the display device 40, the size dp of the pixel 111, the virtual image depth DIL, and the lens inter-pixel distance DXL can be set to satisfy the predetermined resolution. Also, in the display device 40, as in a case in which the irradiation state of light with respect to the sampling region 207 in the first embodiment is iterated in the predetermined cycle λ, the irradiation state of light emitted from each microlens 121 of the microlens array 120 is iterated in units larger than the maximum pupil diameter of the user. Also in the second embodiment, the pitch of the microlenses 121 and the lens inter-pixel distance DXL can be set so that the iteration cycle at that time satisfies the iteration cycle λ determined by a technique similar to the technique described in the above (2-2-3-2. Iteration cycle of irradiation state of sampling region). That is, the iteration cycle λ of the irradiation state of the light can be set to be larger than a pupil distance of the user. The iteration cycle λ of the irradiation state of the light can be set so that a value obtained by multiplying the iteration cycle λ by an integer is substantially equal to the pupil distance of the user.

Also, in the second embodiment, it is desirable that the size of the region of the pixel array 110 visually recognized through one microlens 121 be a size of an integer multiple of a small region including RGB pixels of the pixel array 110. Although different parts of the pixel array 110 are visually recognized through one microlens 121 in accordance with the movement of the viewpoint of the user, a color balance of the overall pixel array 110 visually recognized through one microlens 121 is not lost, and the overall color balance can be made constant as a result, if such a condition is satisfied.

The control unit 430 includes a processor such as a CPU, a DSP, or the like, and operates in accordance with a predetermined program, thereby controlling the driving of each pixel 111 of the pixel array 110. The control unit 430 has a light-ray information generating unit 431 and a pixel driving unit 432 as its functions. Here, the functions of the light-ray information generating unit 431 and the pixel driving unit 432 correspond to those in which some of functions of the light-ray information generating unit 131 and the pixel driving unit 132 in the display device 10 illustrated in FIG. 10 are changed. Hereinafter, in terms of the control unit 430, the description of matters repeated from the control unit 130 of the display device 10 will be omitted and differences from the control unit 130 will mainly be described.

The light-ray information generating unit 431 generates light-ray information for driving each pixel 111 of the pixel array 110 on the basis of the picture information and the virtual image position information. Here, as in the first embodiment, the picture information is two-dimensional picture information presented to the user. However, the virtual image position information is not arbitrarily set as in the first embodiment, but is information about a predetermined virtual image generation position determined in accordance with the lens inter-pixel distance DXL and the focal length of each microlens 121 of the microlens array 120.

Also, in the second embodiment, the light-ray information generating unit 431 generates information indicating a light-ray state in which pictures visually recognized through the microlenses 121 of the microlens array 120 are a continuous and integral display on the basis of the picture information as light-ray information. Also, at that time, the light-ray information generating unit 431 generates the above-described light-ray information so that a virtual image generation position related to the continuous and integral display coincides with a virtual image generation position determined in accordance with a positional relationship between the pixel array 110 and the microlens array 120 based on the virtual image position information and optical characteristics of the microlens 121. Further, in consideration of the magnification in the microlens 121, the light-ray information generating unit 431 may appropriately adjust the above-described light-ray information so that the size of the picture finally observed by the user becomes an appropriate size. The light-ray information generating unit 431 provides the generated light-ray information to the pixel driving unit 432.

Also, the picture information and the virtual image position information may be transmitted from another device or may be stored in advance in a storage device (not illustrated) provided in the display device 40.

The pixel driving unit 432 drives each pixel 111 of the pixel array 110 on the basis of the light-ray information. In the second embodiment, each pixel 111 of the pixel array 110 is driven on the basis of the light-ray information by the pixel driving unit 432 and therefore the light emitted from each microlens 121 is controlled so that pictures visually recognized through each microlens 121 of the microlens array 120 are a continuous and integral display. Thereby, the user can recognize an optical virtual image generated by each microlens 121 as a continuous and integral picture.

As described above, the configuration of the display device 40 according to the second embodiment has been described with reference to FIG. 30.

### 3-3. Display Control Method

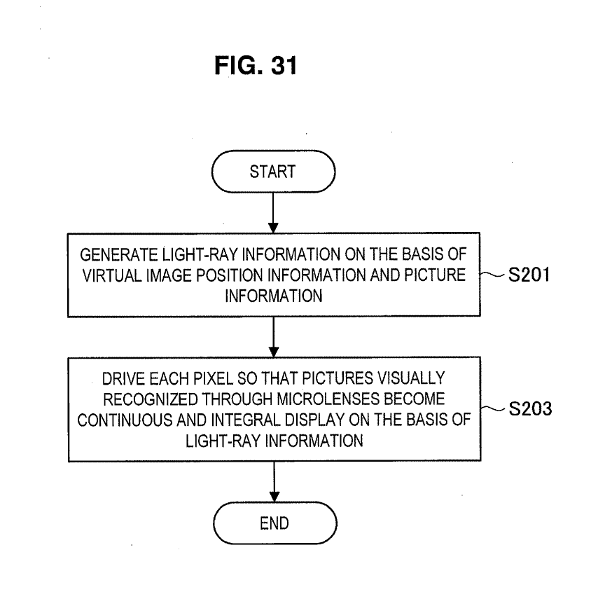

A display control method to be executed in the display device 40 according to the second embodiment will be described with reference to FIG. 31. FIG. 31 is a flowchart illustrating an example of a processing procedure of the display control method according to the second embodiment. Also, each process illustrated in FIG. 31 corresponds to each process to be executed by the control unit 430 illustrated in FIG. 30.

Referring to FIG. 31, in the display control method according to the second embodiment, light-ray information is first generated on the basis of virtual image position information and picture information (step S201). The virtual image position information is information about a position (virtual image generation position) at which a virtual image is generated in the display device 40 illustrated in FIG. 30. In the second embodiment, the virtual image position information is information about a predetermined virtual image generation position determined in accordance with a lens inter-pixel distance DXL and a focal length of each microlens 121 of the microlens array 120. Further, the picture information is two-dimensional picture information to be presented to the user.

In the process shown in step S101, information indicating a light-ray state in which pictures visually recognized through the microlenses 121 of the microlens array 120 are a continuous and integral display is generated as light-ray information on the basis of the picture information. At that time, the above-described light-ray information can be generated so that a virtual image generation position related to the continuous and integral display coincides with a virtual image generation position determined by a positional relationship between the pixel array 110 and the microlens array 120 based on the virtual image position information and the optical characteristics of the microlens 121. Further, in the process shown in step S101, the above-described light-ray information may be appropriately adjusted so that the size of the picture finally observed by the user becomes an appropriate size in consideration of the magnification in the microlens 121.

Next, each pixel is driven so that the picture visually recognized through each microlens 121 of the microlens array 120 becomes a continuous and integral display on the basis of the light-ray information (step S203). As a result, the optical virtual image generated by each microlens 121 is provided as a continuous and integral picture to the user.

The display control method according to the second embodiment has been described above.

### 3-4. Modified Example

As described above, according to the second embodiment, it is possible to make the size dp of the pixel 111 relatively large. However, when the above-described condition 3 is considered, it is necessary to increase the lens inter-pixel distance DXL so as to keep the resolution at a predetermined value when the size dp of the pixel 111 is increased. Accordingly, while the size dp of the pixel 111 can be increased in the display device 40, the lens inter-pixel distance DXL may be increased and the size of the device may be increased depending on the required resolution. Here, as a modified example of the second embodiment, a method of preventing such an increase in the size of the device by devising a configuration for the microlens array 120 will be described.

As a lens system generally used as a telescopic lens, a lens system called a telephoto type is known. In a telephoto type lens system, it is possible to implement a light-ray state equivalent to that of one convex lens located at a more remote position in a more compact configuration by combining a convex lens and a concave lens.

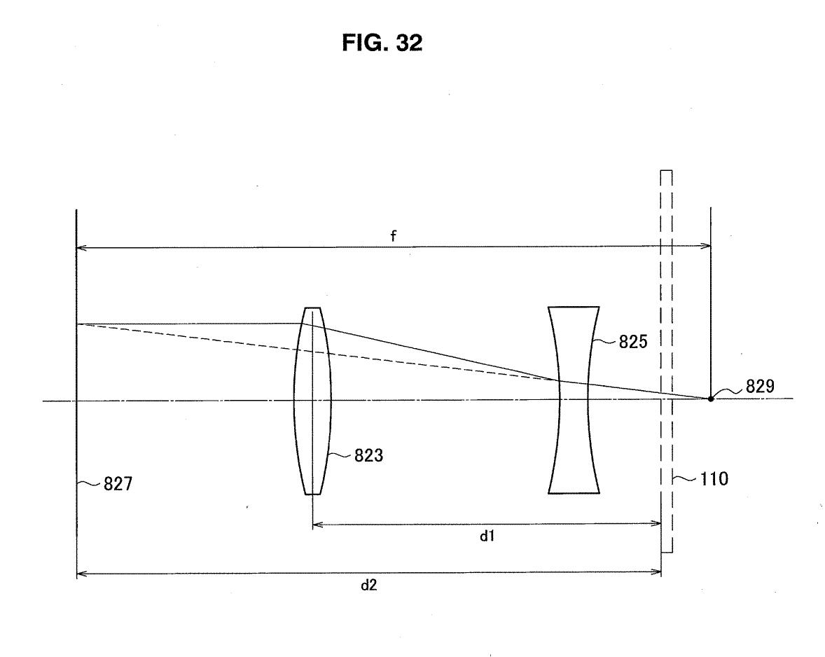

A telephoto type lens system will be described with reference to FIG. 32. FIG. 32 is a diagram illustrating an example of a configuration of a telephoto type lens system.

As illustrated in FIG. 32, a telephoto type lens system is configured by combining a convex lens 823 and a concave lens 825. As illustrated, in the telephoto type lens system, a main surface 827 of a coupling system is located farther away than the convex lens 823 when viewed from the focus 829. That is, the focal length f (a distance between the main surface 827 and the focus 829) is longer than the distance from the focus 829 to the convex lens 823. Here, if it is intended to implement the light-ray state illustrated in FIG. 32 with one convex lens, the convex lens can be located on the main surface 827. As described above, in the telephoto type lens system, it is possible to implement a light-ray state equivalent to that of one convex lens in a more compact configuration.

In the present modified example, each microlens 121 of the microlens array 120 illustrated in FIG. 30 includes such a telephoto type lens system. That is, in the present modified example, each microlens 121 of the microlens array 120 illustrated in FIG. 30 includes a telephoto type lens system in which a convex lens 823 and a concave lens 825 are combined. Specifically, the microlens array 120 is formed by stacking a first microlens array in which convex lenses 823 are arranged and a second microlens array in which concave lenses 825 are arranged.

In this case, for example, as illustrated in FIG. 32, the pixel array 110 can be arranged between the concave lens 825 and the focus 829. For example, as illustrated in FIG. 30, when the microlens array 120 is formed with only a lens array of one layer including convex lenses, the distance between the pixel array 110 and the microlens array 120 can be relatively long (for example, a distance d2 illustrated in FIG. 32) because the microlens array 120 needs to be arranged on the main surface 827 as described above in order to implement the light-ray state illustrated in FIG. 32. On the other hand, by configuring the microlens array 120 with the telephoto type lens system as in the present modified example, it is possible to implement the same light-ray state with a smaller configuration, so that it is possible to further shorten the distance between the pixel array 110 and the microlens array 120 (for example, a distance d1 illustrated in FIG. 32).

As described above, according to the present modified example, in the configuration of the display device 40 illustrated in FIG. 30, the microlens array 120 includes a telephoto type lens system. Accordingly, the distance between the pixel array 110 and the microlens array 120 can be further shortened and the display device can be further downsized.

A modified example in which each microlens 121 of the microlens array 120 includes a telephoto type lens system has been described above as a modified example of the second embodiment.

Also, in addition to the modified examples, various modified examples described in the first embodiment can also be applied to the display device 40 according to the second embodiment. Specifically, the configurations described in the above (2-5-3. Dynamic control of irradiation state in accordance with pupil position detection) and (2-5-4. Modified example in which pixel array is implemented by printing material) may be applied to the display device 40.

Also, the display device 40 according to the second embodiment may be applied to devices similar to various application examples for the display device 10 according to the above-described first embodiment. Specifically, the display device 40 can be applied to various devices described in the above (2-4-1. Application to wearable device), the above (2-4-2. Application to other mobile devices), the above (2-4-3. Application to electronic loupe device) and (2-4-4. Application to in-vehicle display device).

### 4. Configuration of Microlens Array

The configuration of the microlens array 120 in the above-described first and second embodiments will be described in more detail. Here, the configuration of the microlens array 120 in the display device 40 according to the second embodiment will be described as an example. However, the configuration of the microlens array 120 described below can also be preferably applied to the display device 10 according to the first embodiment and the display device 20 according to the modified example.

In the display device 40, a shape of each microlens 121 on the microlens array 120 can be designed in consideration of a viewpoint of a user who views the display device 40. At this time, in accordance with positional relationships between the left and right eyes of the user and the microlens 121, it is necessary to perform the design in consideration of the following two phenomena because an angle formed between a light ray incident on the eyes of the user from the pixels 111 of the pixel array 110 via the microlenses 121 and the optical axis of the microlens 121 varies greatly.

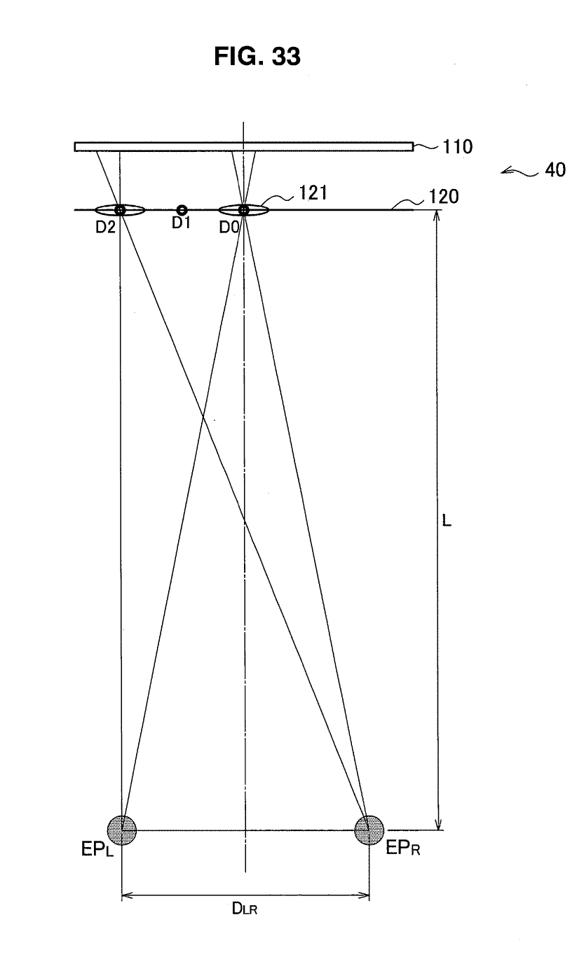

The two phenomena will be described with reference to FIG. 33. FIG. 33 is a diagram schematically illustrating positional relationships between the positions of both eyes of the user who observes the display device 40 and the microlenses 121 of the microlens array 120. In FIG. 33, only three microlenses 121 arranged at positions D0, D1, and D2 among the microlenses 121 included in the microlens array 120 are representatively illustrated. Also, a position EP_{L} of the left eye and a position EP_{R} of the right eye of the user who is observing the display device 40 from the position of a distance L from the microlens array 120 are simulatively shown as spatial points.

For example, in the illustrated example, a case in which the microlens 121 located at the position D2 in front of the left eye of the user is viewed is considered. In this case, while an angle between a straight line connecting the left eye and the microlens 121 (that is, a straight line connecting EP_{L} and D2) and a perpendicular line of the array surface of the microlens array 120 is substantially zero, an angle formed between a straight line connecting the right eye and the microlens 121 (that is, a straight line connecting EP_{R} and D2) and a perpendicular line of the array surface of the microlens array 120 is a non-zero angle. As an example, if a distance L=150 (mm) and a distance D_{LR} between the left and right eyes is D_{LR}=60 (mm), the angle is about 22 degrees.

That is, when viewed from the microlens 121, the right eye and the left eye of the user exist in mutually different directions (angles). In this manner, when the angular difference with respect to the left and right eyes is large, the aberration increases as a first phenomenon and favorable images are not formed on the left and right eyes, that is, favorable display cannot be implemented.

Also, as a second phenomenon, there is concern of occurrence of vignetting. That is, when the microlens array 120 is formed by stacking a plurality of microlens array surfaces (for example, when the microlens array 120 is formed by laminating a plurality of microlens arrays as described in the above (3-4. Modified example), when a microlens array is provided on both the front and back surfaces of the microlens array 120, or the like), so-called vignetting in which light passing through the first microlens array surface does not pass through a desired microlens surface of the second microlens array surface may occur. For example, when the angle difference with respect to the left and right eyes viewed from the microlens 121 is large like at D2, normal light rays without vignetting are incident on the left eye, but vignetting for the right eye may occur and light rays may not be incident normally. When such a situation occurs, problems such as hindrance of normal display and darkening of the picture may occur.

Because generation of aberration and vignetting can hinder favorable display for the user as described above, it is preferable that each microlens 121 of the microlens array 120 be designed to decrease the occurrence of aberration and vignetting. At this time, for example, the microlens array 120 may be configured by two-dimensionally arranging microlenses 121 of the same shape. However, it is extremely difficult to design the shape of each microlens 121 so that favorable display with less aberration and vignetting is implemented in all combinations of positional relationships between the left and right eyes of the user and the microlens 121 while using microlenses 121 having the same shape. The occurrence of aberration and vignetting is considered to be more conspicuous when a display device 40 with a larger screen is observed from a comparatively short distance. In this case, the angular difference with respect to the left and right eyes of the user as viewed from the microlens 121 becomes larger. In such a case, designing the microlenses 121 will be more difficult.

Therefore, in the present disclosure, it is preferable to assume the positions (viewpoints) of the eyes of the user with respect to the display device 40 being at predetermined positions and the shape of each microlens 121 being designed so that favorable image formation is implemented in accordance with the positional relationship between the viewpoint and each microlens 121. That is, the plurality of microlenses 121 are configured to have shapes different from one another so that favorable display can be implemented in consideration of the viewpoint of the user in accordance with the position of each microlens 121 within the array surface of the microlens array 120. Thereby, it is possible to provide the user with more preferable display than when all the microlenses 121 have the same shape.

Also, ideally, it is preferable to optimally design all microlenses 121 on the microlens array 120 depending on their positions. However, if the number of steps or the like involved in design is considered, such a design method is not necessarily realistic. Accordingly, some points (hereinafter also referred to as design points) for optimum design of the microlenses 121 are set on the microlens array and the shape is optimally designed so that the degree of aberration and the occurrence of vignetting are minimized for the microlenses 121 located at these design points. With respect to the microlenses 121 located at positions other than the design points, the shape is designed using the design results for the microlenses 121 located at the design points. Specifically, for example, because trends in change in a shape of the lenses depending on the position on the array surface of the microlens array 120 can be ascertained from the results of the optimum design of microlenses 121 at a plurality of design points, it is simply necessary to design microlenses 121 other than those at the design points on the basis of these trends.

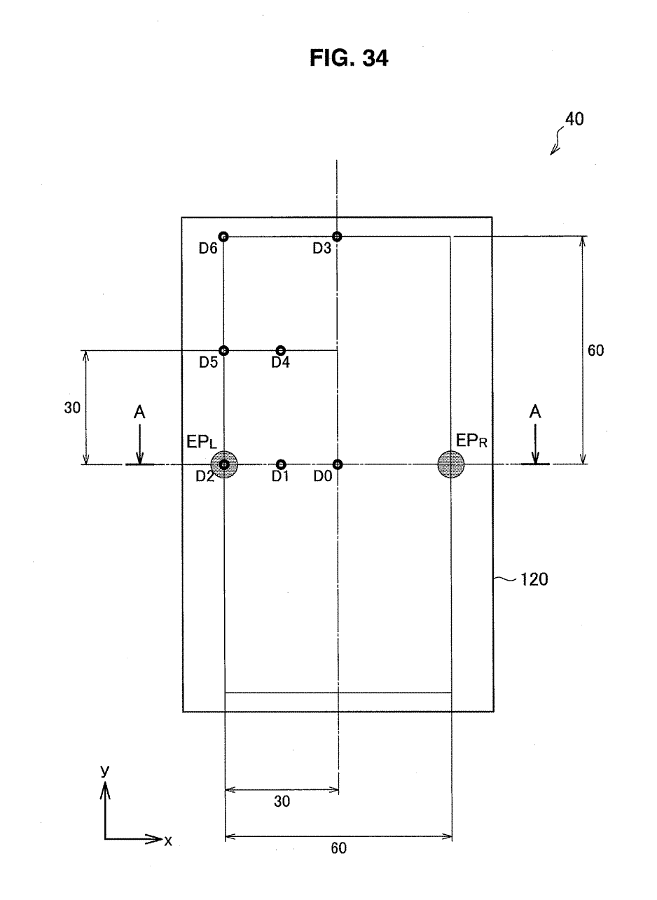

The above-described method of designing the microlens 121 will be described in more detail with reference to FIG. 34. FIG. 34 is an explanatory diagram illustrating the method of designing the microlens 121. In FIG. 34, the microlens array 120 of the display device 40 is illustrated and the design points D0 to D6 set on the microlens array 120 are illustrated. Also, viewpoints (a left eye position EP_{L} and a right eye position EP_{R}) of the user who views the display device 40 (that is, the microlens array 120) are simulatively shown as spatial points.

An example of a specific microlens array 120 and design points D0 to D6 for which the present inventors actually designed the microlenses 121 is illustrated in FIG. 34. In this design example, the display device 40 is assumed to be applied to a display screen of a smartphone and the microlens array 120 has a rectangular array surface of 126 (mm) in length and 80 (mm) in width. Also, hereinafter, for description, a vertical direction of the microlens array 120 in FIG. 34 is also referred to as a y-axis direction and a horizontal direction is referred to as a x-axis direction. FIG. 33 described above corresponds to a cross-sectional view of the microlens array 120 illustrated in FIG. 34 taken along the line A-A parallel to the x-axis.

Also, in the design example, the positions EP_{L} and EP_{R} of the left and right eyes of the user are set at the center of the microlens array 120 in the y-axis direction. EP_{L} and EP_{R} are set at positions symmetrical with respect to the center of the array surface of the microlens array 120 in the x-axis direction and the distance D_{LR} between the left and right eyes (that is, the distance between EP_{L} and EP_{R}) is set to 60 (mm) in consideration of a general pupil distance PD. Although not clearly illustrated in FIG. 34, EP_{L} and EP_{R} do not exist on the same plane as the microlens array 120, and are set at positions separated by predetermined distances from the microlens array 120 in a direction perpendicular to the drawing sheet in consideration of the user's viewing distance. In this specific example, a distance between the microlens array 120 and each of EP_{L} and EP_{R} in the direction perpendicular to the drawing sheet is 150 (mm).

Also, in the design example, seven design points D0 to D6 are set at the illustrated positions. Also, as illustrated, all the design points D0 to D6 exist in the area corresponding to the fourth quadrant of the array surface of the microlens array 120, but this is because a result of optimum design at a point corresponding to a design point in another quadrant can also be easily obtained by appropriately using a result of optimum design if the optimum design of a lens at a design point in one quadrant is performed because the positions EP_{L} and EP_{R} of the left and right eyes of the user are set symmetrically with respect to the center of the array surface of the microlens array 120. Of course, depending on positional relationships between the microlens array 120, EP_{L}, and EP_{R}, design points may be provided to be distributed across the entire surface of the array surface.

For the microlenses 121 located at the design points D0 to D6 set as described above, the optimum design of the shape is performed so that the aberration for the left and right eyes existing at the positions EP_{L} and EP_{R} is decreased. Specifically, the shape of each microlens 121 is designed so that favorable image formation with less aberration (that is, in both right and left eyes) in both EP_{L} and EP_{R} is obtained in consideration of a three-dimensional positional relationship between EP_{L} and EP_{R} (that is, left and right eyes) for each of the microlenses 121 located at the design point D0 to D6. When the microlens array 120 is configured by stacking a plurality of microlens array surfaces, the optimum design of the shape of each of the microlenses 121 on the plurality of microlens array surfaces located at the design points D0 to D6 is performed so that vignetting is further decreased in both EP_{L} and EP_{R} in consideration of three-dimensional positional relationships with EP_{L} and EP_{R}.

When the optimum design is made for the microlens 121 located at each of the design points D0 to D6, from the design results, trends in change in a shape of the microlenses 121 depending on the position on the array surface of the microlens array 120 can be ascertained. For the microlenses 121 other than those located at the design points D0 to D6, the shape is designed on the basis of these trends. Thereby, the shape of each microlens 121 is designed. Each of the designed microlenses 121 preferably has an aspheric shape.

The method of designing the microlens 121 has been described above. By designing the shape of each microlens 121 on the basis of the position of the viewpoint of the user and the position of each microlens 121 within the array surface of the microlens array 120, more preferable display can be provided to the user. Also, in the above-described design example, the shape of the microlenses 121 gradually changes in accordance with the position within the array surface of the microlens array 120, but the method of designing the microlens 121 is not limited to this example. For example, the surface of the microlens array 120 may be divided into a plurality of regions and the shape of the microlenses 121 may be designed for each region. According to this method, although the accuracy of the optimum design of each microlens 121 may be slightly lowered, the entire microlens array 120 can be designed more simply than when the microlenses 121 are individually designed.

Also, the reason why the number of design points in the above-described design example is seven is that trends in change in the shape of the microlenses 121 depending on the position on the array surface of the microlens array 120 can be ascertained through the optimum design of the microlenses 121 at the seven design points D0 to D6 if the microlens array 120 has a degree of size as illustrated, as a result of examination by the present inventors. Because the size of the microlens array 120 changes in accordance with a device to which the display device 40 is applied, the positions of design points and the number of design points can be appropriately set so that the trends in change in the shape of the microlenses can be ascertained in accordance with the size of the microlens array 120.

Further, because the display device 40 is assumed to be applied to the display screen of a smartphone as described above for the setting of EP_{L} and EP_{R} in the above-described design example, an example of the positional relationship between the user and the display surface when a smartphone is used is assumed. When a device to which the display device 40 is applied is different, the positions of EP_{L} and EP_{R} may be appropriately set in consideration of the general positional relationship between the user and the display screen when the device is used. Also, the position of the viewpoint (that is, the combination of the positions of EP_{L} and EP_{R}) is not limited to one position. For example, in a smartphone, both a usage mode in which the user views the display of the display screen in the vertical direction (that is, a usage mode in which the smartphone is used in the direction of the microlens array 120 illustrated in FIG. 33) and a usage mode in which the user views the display of the display screen in the horizontal direction (that is, a usage mode in which the smartphone is used after the microlens array 120 illustrated in FIG. 33 is rotated by 90 degrees around a rotation axis in a direction perpendicular to the drawing sheet) may be considered. Thus, although only the positions of EP_{L} and EP_{R} when the display screen is set in the vertical direction are considered in the above-described design example, the optimum design of the microlenses 121 at the design points D0 to D6 may be performed in consideration of the positions of EP_{L} and EP_{R} when the display screen is set in the horizontal direction in addition thereto.

Here, in the design of the microlenses depending on the position of the viewpoint, the shape of each microlens 121 is designed in the above-described design example. However, the method of designing the microlenses depending on the position of the viewpoint is not limited to this example. For example, when the microlens array 120 is configured by stacking a plurality of microlens array surfaces, a positional relationship between microlenses 121 among the plurality of microlens array surfaces and/or a relationship between the number of microlenses 121 may also be appropriately designed instead of designing the shape of the microlenses 121 as described above or in addition to designing the shape of the microlenses 121 as described above.

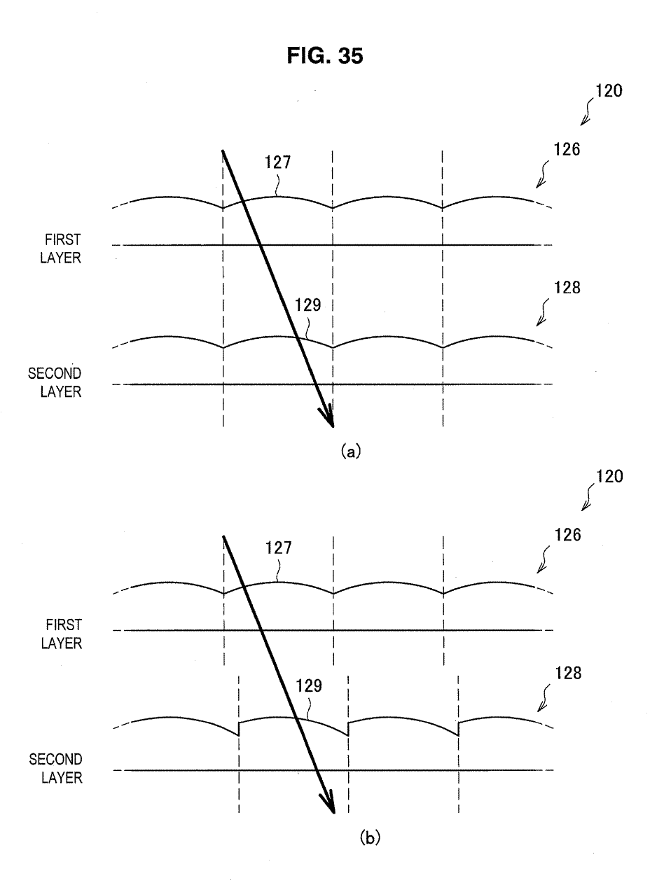

For example, an example of a configuration in which a positional relationship between microlenses 127 and 129 of two-layer microlens arrays 126 and 128 in accordance with a position of a viewpoint of the user is shifted in the microlens array 120 including the two-layer microlens arrays 126 and 128 is illustrated in FIG. 35. As described in the above (3-4. Modified example), when the microlens array 120 includes the two-layer microlens arrays 126 and 128, the microlens array 120 can be assumed to be configured normally so that the position of the boundary between the microlenses 127 in the first-layer microlens array 126 and the position of the boundary between the microlenses 129 in the second-layer microlens array 128 substantially coincide. The upper portion ((a) in FIG. 35) of FIG. 35 schematically illustrates the configuration. In this case, the position of the boundary between the microlenses 127 and 129 is designed by assuming that the light from the pixels 111 of the pixel array 110 passes through the microlenses 127 and 129 overlapping each other and is incident on the eyes of the user.

Here, a case in which the direction from either the left or right eye of the user towards the microlenses 127 and 129 (that is, the direction of the visual line at either the left or the right of the user) is inclined by a predetermined angle from the optical axis of the microlenses 127 and 129 as indicated by an arrow in FIG. 35 is considered. The arrow illustrated in FIG. 35 corresponds to, for example, a case in which the microlenses 127 and 129 located at the position D2 illustrated in FIG. 33 are viewed with the right eye (EP_{R}). In this case, there is a high possibility that light from the pixel 111 will not pass through the corresponding microlenses 127 and 129 normally, that is, vignetting will occur.

Therefore, when a microlens depending on the position of the viewpoint is designed, the positional relationship between the microlenses 127 and 129 in the two-layer microlens arrays 126 and 128 may be appropriately adjusted so that vignetting is less likely to occur as illustrated in the lower portion of FIG. 35 ((b) in FIG. 35). Specifically, the position of the boundary between the microlenses 127 within a plane horizontal to the array surface in the first-layer microlens array 126 and the position of the boundary between the microlenses 129 within a plane horizontal to the array surface in the second-layer microlens array 128 may be appropriately shifted so that vignetting is less likely to occur in accordance with the position of the viewpoint of the user. In the illustrated example, the boundary position of the microlenses 129 of the second-layer microlens array 128 within the plane is shifted to correspond to the direction of the visual line of the user indicated by the arrow in FIG. 35. As described above, the microlens array 120 can be configured so that vignetting is less likely to occur in accordance with the position of the user's viewpoint by configuring the microlens array 120 so that the position of the boundary between the microlenses 127 in the first-layer microlens array 126 and the position of the boundary between the microlenses 129 in the second-layer microlens array 128 are different from each other.

When this configuration is applied to the entire microlens array 120, it is only necessary to design the positional relationship of the optimum boundaries of the two-layer microlens arrays 126 and 128 for a plurality of design points D0 to D6 within the array surface of the microlens array 120 as illustrated in, for example, FIG. 34. It is only necessary to acquire a distribution of shift amounts of the microlens arrays 126 and 128 depending on positions within the array surface of the microlens array 120 from the design results at the design points D0 to D6 and calculate shift amounts of the microlens arrays 126 and 128 at positions other than design points on the basis of the distribution. Alternatively, the array surface of the microlens array 120 may be divided into a plurality of regions and the shift amounts of the microlens arrays 126 and 128 may be determined for each region using the above-described distribution.

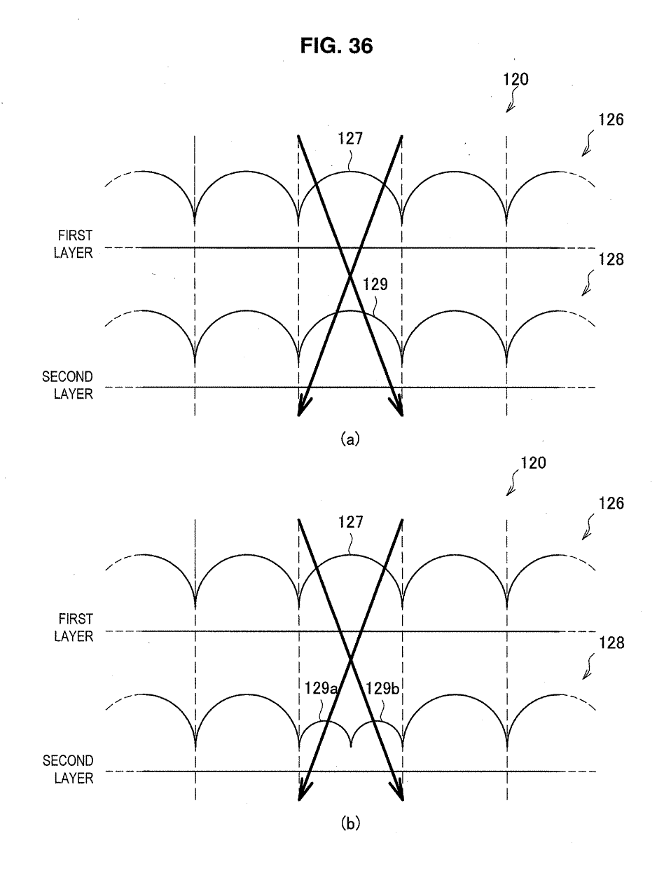

Also, for example, FIG. 36 is a diagram illustrating an example of a configuration in which the number of microlenses to which the two-layer microlens arrays 126 and 128 mutually correspond changes in accordance with the position of the viewpoint of the user in the microlens array 120 including the two-layer microlens arrays 126 and 128. As described in the above (3-4. Modified example), when the microlens array 120 includes the two-layer microlens arrays 126 and 128, the microlens array 120 can be assumed to be configured so that the microlenses 127 in the first-layer microlens array 126 and the microlenses 129 in the second-layer microlens array 128 have one-to-one correspondence. The upper portion ((a) in FIG. 36) of FIG. 36 schematically illustrates this configuration.

Here, a case in which the directions from the left and right eyes of the user to the microlenses 127 and 129 (that is, the directions of the visual lines at the left and right eyes of the user) are different directions in the left and right eyes as indicated by arrows in FIG. 36 is considered. The arrows illustrated in FIG. 36 correspond to, for example, a case in which the microlenses 127 and 129 located at the position D0 illustrated in FIG. 33 are viewed with both eyes (EP_{L} and EP_{R}). In this case, it may be difficult to design both the shapes of the microlenses 127 and 129 so that the shapes can correspond to both the visual lines from the left and right eyes.

Therefore, when the optimum design of the microlenses depending on the position of the viewpoint is performed, the microlens array 120 may be configured so that the two microlenses 129a and 129b in the second-layer microlens array 128 correspond to one microlens 127 in the first-layer microlens array 126 as illustrated in the lower portion of FIG. 36 ((b) in FIG. 36). That is, the microlenses 129 of the other microlens array 128 corresponding to one microlens 127 of one microlens array 126 may be appropriately divided in accordance with a difference between the directions of the visual lines from the plurality of viewpoints. One microlens 129a obtained through the division corresponds to one viewpoint (for example, the left eye) and the other microlens 129b corresponds to the other viewpoint (for example, the right eye). At this time, the shapes of the microlenses 129a and 129b obtained by the division may be appropriately designed to obtain favorable display. In this manner, the microlens array 120 is configured so that the plurality of microlenses 129a and 129b in the second-layer microlens array 128 correspond to one microlens 127 of the first-layer microlens array 126, so that the microlens array 120 can be configured to prevent aberration from occurring in accordance with the viewpoint of the user. Also, in the illustrated example, one type of microlens 129 in the second-layer microlens array 128 are divided into two microlenses 129a and 129b, but the number of divisions of the microlenses 129 may be larger. That is, a plurality of microlenses may be formed in the second-layer microlens array 128 for one microlens 127 in the first-layer microlens array 126. Also, the microlenses 127 of the first-layer microlens array 126 may be divided. That is, a plurality of microlenses may be formed in the first-layer microlens array 126 with respect to one type of microlens 129 in the second-layer microlens array 128.

When this configuration is applied to the entire microlens array 120, it is only necessary to design the number of optimal microlenses 127 and 129 in the two-layer microlens arrays 126 and 128 and the arrangement of the optimal microlenses 127 and 129 at, for example, a plurality of design points D0 to D6 within the array surface of the microlens array 120 as illustrated in FIG. 34. It is only necessary to acquire the number of microlenses 127 and 129 within the array surface of the microlens array 120 and a distribution of arrangements from the design results at the design points D0 to D6 and design the number of microlenses 127 and 129 and the arrangements of microlenses 127 and 129 at positions other than design points on the basis of the distribution. Alternatively, the array surface of the microlens array 120 may be divided into a plurality of regions and the number of microlenses 127 and 129 and the arrangements of microlenses 127 and 129 may be determined for each region using the above-described distribution.

Also, although a case in which the microlens array 120 is configured by stacking a plurality of microlens arrays has been described in the examples illustrated in FIGS. 35 and 36, the configuration of the microlens array 120 to which the above-described design method of shifting the boundary between the microlenses and the above-described design method of dividing the microlenses can be applied is not limited to this example. For example, even for a microlens array 120 including one layer (one piece) having microlens array surfaces formed on the front and back sides or a microlens array 120 having three or more microlens array surfaces, design methods thereof may be applied in a similar type.

As described above, by designing the microlens array 120 in consideration of the viewpoint of the user, aberration and vignetting can be decreased in the entire screen and the effect of visual acuity compensation can be obtained in a more appropriate state. Also, as compared with when the microlens array 120 is formed by microlenses 121 having the same shape, it is possible to relax restriction requirements of design. In some cases, because it is also possible to decrease the number of layers of microlens arrays included in the microlens array 120 for implementing similar performance, a decrease in manufacturing costs can be implemented as a result.

Also, if the above-described design method is used in reverse, it is also possible to configure the microlens array 120 so that it is difficult to view a display from a predetermined viewpoint, that is, so that the aberration becomes large at a predetermined viewpoint and/or the occurrence of vignetting becomes conspicuous and the display becomes unclear. According to this configuration, prying from the surroundings can be suitably prevented.

### 5. Supplement

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

Further, the effects described in this specification are merely illustrative or exemplified effects, and are not limitative. That is, with or in the place of the above effects, the technology according to the present disclosure may achieve other effects that are clear to those skilled in the art from the description of this specification.

Also, the above-described device configurations of the display devices 10, 20, and 40 are not limited to the examples illustrated in FIGS. 10, 28, and 30. For example, the functions of the control units 130, 230, and 430 may not necessarily be integrally mounted in one device. The functions of the control units 130, 230, and 430 may be distributed and mounted on a plurality of devices (for example, a plurality of processors) and the plurality of devices may be connected to communicate with one another so that the functions of the above-described control units 130, 230, and 430 may be implemented.

Also, a computer program for implementing the functions of the control units 130, 230, and 430 as described above can be manufactured and mounted on a personal computer or the like. Also, it is possible to provide a computer-readable recording medium in which such a computer program is stored. The recording medium is, for example, a magnetic disk, an optical disc, a magneto-optical disc, a flash memory, or the like. Also, the computer program may be distributed via, for example, a network, without using a recording medium.

Additionally, the present technology may also be configured as below.

(1)

A display device including:

a pixel array; and

a microlens array provided on a display surface side of the pixel array and having lenses arranged at a pitch larger than a pixel pitch of the pixel array,

wherein the microlens array is arranged so that each lens of the microlens array generates a virtual image of display of the pixel array on a side opposite to a display surface of the pixel array, and

light emitted from each lens of the microlens array is controlled so that pictures visually recognized through lenses of the microlens array become a continuous and integral display by controlling the light from each pixel of the pixel array.

(2)

The display device according to (1), wherein an irradiation state of light emitted from each lens of the microlens array is periodically iterated in units larger than a maximum pupil diameter of a user.

(3)

The display device according to (2), wherein an iteration cycle of the irradiation state of the light is larger than a pupil distance of the user.

(4)

The display device according to (2) or (3), wherein a value obtained by multiplying an iteration cycle of the irradiation state of the light by an integer is substantially equal to a pupil distance of the user.

(5)

The display device according to any one of (2) to 4, wherein light emitted from each lens of the microlens array is controlled so that a pupil of the user is not located on a boundary of iteration of the irradiation state of the light in accordance with a position of the pupil of the user.

(6)

The display device according to any one of (1) to (5), wherein each lens of the microlens array includes a telephoto type lens system in which a convex lens and a concave lens are combined.

(7)

The display device according to any one of (1) to (6), further including:

a movable mechanism configured to make a distance between the pixel array and the microlens array variable.

(8)

The display device according to any one of (1) to (7), wherein light emitted from each lens of the microlens array is controlled so that a picture captured by an imaging device is visually recognized as an integral display through each lens of the microlens array.

(9)

The display device according to any one of (1) to (7), wherein the pixel array includes a plurality of printed pixels.

(10)

The display device according to any one of (1) to (9), wherein each lens of the microlens array has a surface shape differing in accordance with a position of the lens within an array surface.

(11)

The display device according to any one of (1) to (10),

wherein the microlens array is configured by stacking a plurality of microlens array surfaces, and

one microlens array surface and at least one other microlens array surface among the plurality of microlens array surfaces are formed so that boundary positions between lenses within surfaces horizontal to the array surfaces are different from each other.

(12)

The display device according to any one of (1) to (11),

wherein the microlens array is configured by stacking a plurality of microlens array surfaces, and

one microlens array surface and at least one other microlens array surface among the plurality of microlens array surfaces are formed so that a plurality of lenses in the at least one other microlens array correspond to one lens of the one microlens array surface.

(13)

The display device according to any one of (10) to (12), wherein each lens of the microlens array has an aspheric shape.

(14)

The display device according to any one of (10) to (13), wherein each lens of the microlens array is designed so that display is unclear at a position of a predetermined viewpoint of a user.

(15)

The display device according to any one of (10) to (14), wherein the display device is used as an in-vehicle display device on which driving support information is displayed.

(16)

A display control method including:

controlling light emitted from each lens of a microlens array so that pictures visually recognized through lenses of the microlens array become a continuous and integral display by controlling light from each pixel of a pixel array, the microlens array being provided on a display surface side of the pixel array and having lenses arranged at a pitch larger than a pixel pitch of the pixel array,

wherein the microlens array is arranged so that each lens of the microlens array generates a virtual image of display of the pixel array on a side opposite to a display surface of the pixel array.

### REFERENCE SIGNS LIST

10, 20, 40 display device
30 wearable device
110 pixel array
111 pixel
120 microlens array
121 microlens
130, 230, 430 control unit
131, 431 light-ray information generating unit
132, 432 pixel driving unit
150 virtual image surface
231 pupil position detecting unit
310, 320, 333 first shielding plate (aperture film)
311, 321 opening

1. A display device comprising:
a pixel array; and
a microlens array provided on a display surface side of the pixel array and having lenses arranged at a pitch larger than a pixel pitch of the pixel array, wherein
the microlens array is arranged so that each lens of the microlens array generates a virtual image of display of the pixel array on a side opposite to a display surface of the pixel array, and
light emitted from each lens of the microlens array is controlled so that pictures visually recognized through lenses of the microlens array become a continuous and integral display by controlling the light from each pixel of the pixel array.

2. The display device according to claim 1, wherein
an irradiation state of light emitted from each lens of the microlens array is periodically iterated in units larger than a maximum pupil diameter of a user.

3. The display device according to claim 2, wherein
an iteration cycle of the irradiation state of the light is larger than a pupil distance of the user.

4. The display device according to claim 2, wherein
a value obtained by multiplying an iteration cycle of the irradiation state of the light by an integer is substantially equal to a pupil distance of the user.

5. The display device according to claim 2, wherein
light emitted from each lens of the microlens array is controlled so that a pupil of the user is not located on a boundary of iteration of the irradiation state of the light in accordance with a position of the pupil of the user.

6. The display device according to claim 1, wherein
each lens of the microlens array includes a telephoto type lens system in which a convex lens and a concave lens are combined.

7. The display device according to claim 1, further comprising:
a movable mechanism configured to make a distance between the pixel array and the microlens array variable.

8. The display device according to claim 1, wherein
light emitted from each lens of the microlens array is controlled so that a picture captured by an imaging device is visually recognized as an integral display through each lens of the microlens array.

9. The display device according to claim 1, wherein
the pixel array includes a plurality of printed pixels.

10. The display device according to claim 1, wherein
each lens of the microlens array has a surface shape differing in accordance with a position of the lens within an array surface.

11. The display device according to claim 1, wherein
the microlens array is configured by stacking a plurality of microlens array surfaces, and
one microlens array surface and at least one other microlens array surface among the plurality of microlens array surfaces are formed so that boundary positions between lenses within surfaces horizontal to the array surfaces are different from each other.

12. The display device according to claim 1, wherein
the microlens array is configured by stacking a plurality of microlens array surfaces, and
one microlens array surface and at least one other microlens array surface among the plurality of microlens array surfaces are formed so that a plurality of lenses in the at least one other microlens array correspond to one lens of the one microlens array surface.

13. The display device according to claim 10, wherein
each lens of the microlens array has an aspheric shape.

14. The display device according to claim 10, wherein
each lens of the microlens array is designed so that display is unclear at a position of a predetermined viewpoint of a user.

15. The display device according to claim 1, wherein
the display device is used as an in-vehicle display device on which driving support information is displayed.

16. A display control method comprising:
controlling light emitted from each lens of a microlens array so that pictures visually recognized through lenses of the microlens array become a continuous and integral display by controlling light from each pixel of a pixel array, the microlens array being provided on a display surface side of the pixel array and having lenses arranged at a pitch larger than a pixel pitch of the pixel array, wherein
the microlens array is arranged so that each lens of the microlens array generates a virtual image of display of the pixel array on a side opposite to a display surface of the pixel array.
